(19) United States
(12) Patent Application Publication
(10) Pub. No.: US 2025/0005240 A1
(43) Pub. Date: Jan. 2, 2025

(54) METHOD AND SYSTEM FOR EMULATING IC DESIGN WITH FPGA, AND STORAGE MEDIUM

(71) Applicant: SHANGHAI UNIVISTA INDUSTRIAL SOFTWARE GROUP CO., LTD., SHANGHAI (CN)

(72) Inventors: Jingxuan CHI, SHANGHAI (CN); Jiong CAO, SHANGHAI (CN); Cheng LI, SHANGHAI (CN)

(21) Appl. No.: 18/276,731

(22) PCT Filed: Jul. 25, 2023
(86) PCT No.: PCT/CN2023/109197

§ 371 Date: Aug. 10, 2023

(30) Foreign Application Priority Data
Aug. 24, 2022 (CN) CN202211018460.8
Jun. 5, 2023 (CN) CN202310658649.1

(51) Int. Cl. G06F 30/32

(52) U.S. Cl. CPC G06F 30/32

(57) ABSTRACT

The invention relates to the technical field of electronic design automation (EDA), specially relates to a method and a system for emulating IC design with an FPGA, and a storage medium. By identifying ports of sequential cells, the sequential cells are labeled as group A and group B according to the conditions that a data output of a sequential cell is connected to a user clock input of another sequential cell or is not connected to the user clock input of the other sequential cell but is connected to a data input of the other one sequential cell. All sequential cells in the group A is substituted with clock models_{[CA]}, and all sequential cells in the group B is substituted with clock models_{[CB]}. The clock model_{[CA]} and the clock model_{[CB]} solve glitch problem by connecting glitch-containing user clock to a user enable non-sensitive to glitch. By configuring primary clocks′, each of the group A and the group B is driven by a primary clock′, thereby reducing numbers of clock domains, and the whole system can be simultaneously started-up and paused by controlling the primary clocks′.

### RELATED APPLICATIONS

The application is the U.S. national phase of PCT/CN2023/109197 filed Jul. 25, 2023, which claims the benefit of CN202211018460.8 filed Aug. 24, 2022 and CN202310658649.1 filed Jun. 5, 2023, each of which is incorporated herein by reference in its entirety.

### FIELD OF THE INVENTION

The invention relates to the technical field of electronic design automation (EDA), specially relates to a method and a system for emulating an IC design with an FPGA, and a storage medium.

### BACKGROUND OF THE INVENTION

Integrated circuit design (IC design) is a design flow with IC or super-large-scale IC as target. IC design comprises application specific integrated circuit (ASIC) design, and ASIC is IC designed and manufactured according to requirements of specific users and needs of specific electronic systems. After the IC design is completed, it will enter tape-out stage, the cost of the tape-out is very high, and once there is a problem, it can result in tape-out failure. In order to reduce the risk of tape-out failure, it is necessary to fully validate software and hardware in the IC before tape-out, so as to timely discover some problems that are difficult to find in the design process and timely adjust the design to ensure the smooth progress of the tape-out. Common verification tools include simulation and emulation. Emulation refers to simulating hardware actually used in the chip design by the user and then emulate it. Emulation is mostly based on field programmable gate array (FPGA) chip for design. The FPGA chip comprises components such as lookup table (LUT) and register, and different functions can be realized by configuring electrical signals of corresponding components through software.

Because the physical structures of IC and FPGA are different, IC design is based on a standard cell library, and FPGA is based on a macro-cell module (lookup table) provided by a manufacturer, if you want to verify the IC design with the FPGA, a certain conversion must be made on the IC design to transplant it on the FPGA. The biggest difference between the cores of an IC and an FPGA chip is a clock structure. The clock structure in an IC includes at least one clock tree, and each clock tree has a clock tree structure composed of a primary clock and a plurality of generated clocks. In an IC design before wiring design, due to circuit delay, glitches are present in the generated clocks generated by combinatorial logic operations. If the generated clocks with glitches are connected to a clock input of a sequential cell, because the clock input of the sequential cell is sensitive to glitches, the sequential cell is mistakenly triggered to sample signals from the data input, resulting in error of the data sample output by a data output of the sequential cell. In order to solve the glitch problem, the delay of combination logic input signal can be controlled by strict wiring design in IC design, and then the generation of glitch can be controlled. However, if IC design is directly applied on FPGA, since FPGA is a pre-wired semi-custom circuit, the generation of glitches cannot be controlled in the manner of controlling delay by controlling wiring length, and the problem of glitch-caused error data sample output by the sequential cell cannot be avoided.

### OBJECTS AND SUMMARY OF THE INVENTION

It is an object of the claimed invention to overcome some or all of these shortcomings.

For this, according to the first aspect, the present invention provides a method for emulating an IC design with an FPGA, comprising the steps of:
S1) identifying in the IC design: a primary clock, a subcircuit, a plurality of generated clocks and a plurality of sequential cells, wherein the plurality of generated clocks are derived from the primary clock after being processed by the subcircuit, and a user clock being connected to one of the plurality of sequential cells is the primary clock or one of the plurality of generated clocks.
S2) classifying the plurality of sequential cells into group A or group B, wherein, a sequential cell in the a plurality of sequential cells is labelled as group A or group B, including: identifying on the sequential cell: a user clock by which the sequential cell is driven, a data input, a user-clock input and a data output, wherein the user clock is connected the user-clock input; labeling the sequential cell as group A if the data output is connected to a user-clock input of another sequential cell; and labeling the sequential cell as group B if the data output is not connected to a user-clock input of the other sequential cell but is connected to a data input of the other sequential cell.
S3) adapting the plurality of sequential cells, including: 3.1) modifying the sequential cells that are labeled as group A; 3.2) modifying sequential cells that are labelled as group B; and 3.3) configuring a primary clock′.
3.1) modifying the sequential cells that are labeled as group A, including: configuring a clock model_{[CA]}, which includes a data input_{[CA]}, a data output_{[CA]}, a user enable_{[CA]} and a clock input_{[CA]}; modifying one sequential cell_{[A]} in the a plurality of sequential cells labelled as group A, including: identifying in view of S2: a user clock_{[A]} by which the sequential cell_{[A]} is driven, a data input_{[A]}, a user-clock input_{[A]} to which the user clock_{[A]} is connected and a data output_{[A]}, wherein the user clock_{[A]} is connected to the user-clock input_{[A]}; substituting the clock model_{[CA]} for the sequential cell_{[A]}, including: connecting the data input_{[CA]} to what was connected to the data input_{[A]}, connecting the data output_{[CA]} to what was connected to the data output_{[A]}, connecting the user enable_{[CA]} to what was connected to the user-clock input_{[A]} and connecting the clock input_{[CA]} to the primary clock′, wherein the primary clock′ is equal to or greater than the primary clock in frequencies; configuring a clock model_{[CA]}, including: sampling a signal from the data input_{[CA]} at an active edge of the primary clock′ to obtain a data sample for a period of the primary clock′ led by the active edge; when an N-th active edge is occurring on the user clock_{[A]}: obtaining a data sample_{[N]} for a contemporary period of the primary clock′, and outputting to the data output_{[CA]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′, and outputting to the data output_{[CA]} the data sample_{[N+1]} until an N+2-th active edge occurs on the user clock_{[A]}.
3.2) modifying the sequential cells that are labeled as group B, including: configuring a clock model_{[CB]}, which includes a data input_{[CB]}, a data output_{[CB]}, a user enable_{[CB]} and a clock input_{[C]}; modifying a sequential cell_{[B]} in the plurality of sequential cells being labelled as group B, including: identifying in view of S2: a user clock_{[B]} by which the sequential cell_{[B]} is driven, a data input_{[B]}, a user-clock input_{[B]} and a data output_{[B]}, wherein the user clock_{[B]} is connected to the user-clock input_{[B]}; substituting the clock model_{[CB]} for the sequential cell_{[B]}, including: connecting the data input_{[CB]} to what was connected to the data input_{[B]}, connecting the data output_{[CB]} to what was connected to the data output_{[B]}, connecting the user enable_{[B]} to what was connected to the user-clock input_{[B]} and connecting the clock input_{[CB]} to a primary clock′; configuring a clock model_{[CB]}, including: when an active edge is occurring on the user clock_{[B]} and when an active edge is occurring on the primary clock′: s sampling a signal from the data input_{[CB]} to obtain a data sample for a period of the primary clock′ led by the active edge on the primary clock′, and outputting to the data output_{[CB]} the data sample; when no active edge occurs on the user clock_{[B]} or no active edge occurs on the primary clock′: sampling nothing from the data input_{[CB]}, and outputting nothing to the data output_{[CB]}.
3.3) configuring the primary clock′ such that: the primary clock′ by which the clock model_{[CA]} is driven triggers an active edge at a same point_{[TA]} in a period across the clock models_{[CA]}; the primary clock′ by which the clock model_{[CB]} is driven triggers an active edge at a same point_{[B]} in a period across the clock models_{[CB]}; and TB=TA+Δt for a same period of the primary clock′, wherein: a minimum threshold<Δt<a period of the primary clock′; wherein the minimum threshold is a maximum of delays across the user clocks_{[B]} connected to the clock models_{[CB]} for replacing the plurality of sequential cells being labeled as group B; and the delay is a time lag between when an active edge occurring on a user clock_{[B]} is being inputted into a clock detector in the clock model_{[CB]} driven by the user clock_{[B]} and when the active edge is being outputted from the clock detector.

The second aspect, the present invention provides a system for emulating an IC design with an FPGA, comprising a processor and a computer-readable storage medium in communication with the processor, wherein: the system implements the method in claim 1 when the processor executes a program in the computer-readable storage medium.

The third aspect, the present invention provides a non-transitory computer-readable storage medium in which at least one instruction or at least one program is stored, wherein: the at least one instruction or the at least one program is loadable and executable by a processor to implement the method for emulating an IC design with an FPGA.

The present invention has at least the following beneficial effects:

The present invention provides a method for emulating an IC design with an FPGA, comprising the steps of: firstly identifying a port of a sequential cell, and labeling the sequential cell as group A if the data output of the sequential cell is connected to a user-clock input of another sequential cell; labeling the sequential cell as group B if the data output of the sequential cell is not connected to a user-clock input of the other one sequential cell but is connected to a data input of the other sequential cell; substituting the a clock model_{[CA]} for all sequential cells that are labeled as group A, modifying a clock model_{[CB]} for all sequential cells that labeled as group B; the clock model_{[CA]} and the clock model_{[CB]} solving glitch problem by connecting glitch-containing user clock with a user enable non-sensitive to glitch; connecting the clock model_{[CA]} in group A to the same primary clock′, connecting the clock model_{[CB]} in group B to the same primary clock′, so as to be able to greatly reduce numbers of clock domains, thereby reducing resource consumption and making the whole system paused by controlling less primary clocks′; and by configuring a clock offset between the primary clock′ connected to the clock model_{[CA]} and the primary clock′ connected to the clock model_{[CB]}, both are sampled in the same clock period.

### BRIEF DESCRIPTION OF FIGURES

Other advantages, objectives and features of the present invention are in non-limiting description in at least one specific example for describing a method and a system for emulating an IC design with an FPGA and a storage medium and according to the figures, wherein:

FIG. 1 is a structure schematic drawing of a clock model_{[CA]} provided by an example in the prevent invention;

FIG. 2 is a structure schematic drawing of a clock model_{[CB]} provided by an example in the prevent invention;

FIG. 3 is comparison diagram of a sequential cell before and after being to what a clock model is substituted for;

FIG. 4 is timing sequence schematic drawing of clock model_{[CB]} before the primary clock′ shifts;

FIG. 5 is timing sequence comparison schematic drawing of clock model_{[CB]} before and after the primary clock′ shifts;

FIG. 6 is comparison schematic drawing of ideal condition in prior art to actually generated glitches;

FIG. 7 is a flow diagram of a method for emulating an IC design based on FPGA provided by an example of the present invention;

FIG. 8 is flow diagram of S2 provided by an example of the present invention;

FIG. 9 is flow diagram of S3 provided by an example of the present invention;

FIG. 10 is a schematic drawing of a sequential cell for which a clock model_{[CA]} is substituted;

FIG. 11 is a structure schematic drawing of a clock model_{[CA]} provided by another example in the prevent invention;

FIG. 12 is a structure schematic drawing of a clock model_{[CB]} provided by another one example in the prevent invention;

FIG. 13 is a structure schematic drawing of a clock model_{[B]} provided by another one example in the prevent invention;

FIG. 14 is a structure schematic drawing of a clock model_{[CB]} provided by another example in the prevent invention;

FIG. 15 is a structure schematic drawing of a sequential cell after being substituted with a clock model;

FIG. 16 is a structure schematic drawing of a clock detector for a clock model_{[CA]} and a clock model_{[CB]} jointly and provided in the present invention;

FIG. 17 is a structure schematic drawing of a clock detector for two clock models_{[CA]} jointly and provided in the present invention; and

FIG. 18 is a structure schematic drawing of a clock detector for two clock models_{[CB]} jointly and provided in the present invention.

### DETAILED DESCRIPTION OF THE EMBODIMENTS

A clock structure in IC design comprises at least one clock tree, and each clock tree is composed of a primary clock and a plurality of generated clocks. The primary clock is a clock input source in IC design, usually representing the physical clock. The generated clocks are derived from the primary clock after being processed by the subcircuit. The subcircuit can be a frequency divider, a gate clock or a multiplexer. Preferably, the subcircuit is a combinational logic circuit, a sequential logic circuit or a hybrid circuit of a combinational logic circuit and a sequential logic circuit, wherein the frequency divider is a sequential logic circuit, and the gate clock and the multiplexer are combinational logic circuits. Different generated clocks are derived from the primary clock after being processed by different subcircuits, and next-level generated clocks can be derived from the generated clocks after being processing by another subcircuit, and so on, to form a clock tree structure. The generated clocks are used to connect user-clock inputs of a plurality of sequential cells to drive the sequential cells for data sampling. The types of sequential cells can be a register, a latch, a memory, etc. The sequential cell comprises a user-clock input, a data input and a data output. When the active edge of the user clock connected to the user-clock input occurs, the sequential cell is triggered to data sample signal connected to the data input, and data sample is output by the data output, wherein, the data sample output from the data output of the sequential cell can be used as a user clock to be connected to a user-clock input of another sequential cell, and also can be used as a data signal to be connected to a data input of another one sequential cell.

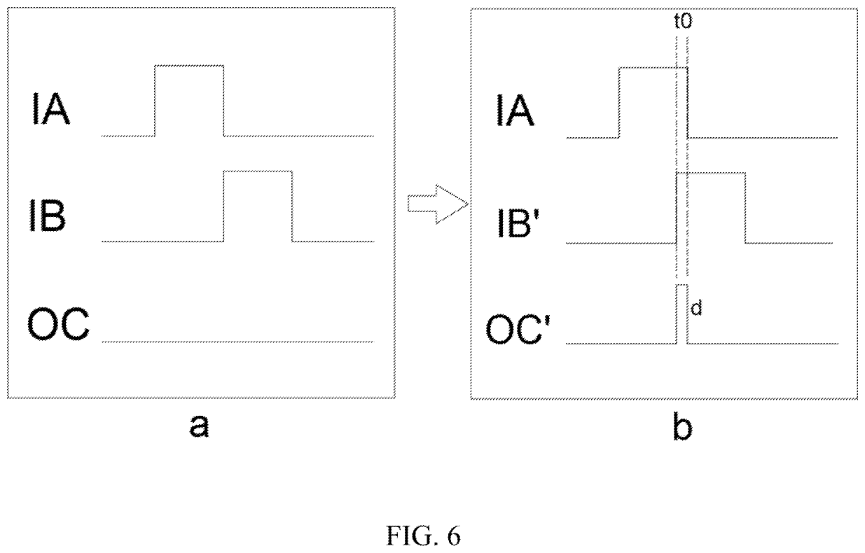

In an IC design before wiring design, glitches are present in the generated clocks generated by combinatorial logic operations due to circuit delay. If the generated clocks having glitches are connected to a clock input of a sequential cell, because the clock input of the sequential cell is sensitive to glitches, the sequential cell is mistakenly triggered to sample signals from the data input, and it cannot avoid the problem of outputting error data sample from the data output of the sequential cell. To better understand where glitches come from, an AND gate circuit with two inputs is adopted for example for description, referring to FIG. 6. In FIG. 6, the two inputs of the AND gate circuit are respectively inputs with a wave signal IA and a wave signal IB, and the wave signal output from the output of the AND gate is OC. However, in the case of delay control without wiring design, due to the delay caused by wiring length or the delay caused by the operation of the previous-level circuit, it cannot guarantee that the signals from the two inputs of the AND gate circuit flip according to a preset time interval. When delays of the waveform signals input by the two inputs of the AND gate circuit are inconsistent, as shown in FIG. 6, and if the delay time of the waveform signal IB′ input by the AND gate circuit is to compared to the waveform signal IA, at this time, the waveform signal output by the AND gate circuit is OC′ with d, wherein, compared with the ideal waveform signal OC, it appears d which should not appear in OC′, and d is the glitch. That is to say, due to the delay, the arrival times of a plurality of signals that should be input at the same time have a sequential relationship, forming a competition relationship, and the error output generated by the competition is glitch.

In order to solve the glitch problem, the delay of combination logic input signal can be controlled by strict wiring design in IC design, and then the generation of glitches can be controlled. However, if IC design is directly applied on an FPGA, since the FPGA is a pre-wired semi-custom circuit, the generation of glitches cannot be controlled in the manner of controlling delay by controlling wiring length. In order to solve the problem of sampling error caused by inputting glitch-containing generated clock to the clock input of a sequential cell and realize application of the sequential cell in IC design on FPGA at the same time, the invention provides two functionally-equivalent clock models for replacement. By connecting the user clock to the user enable of the clock model, the influence of glitch on the data sample is eliminated. Combined with the clock model, the new primary clock′ is connected for equivalent emulation of function of the sequential cell in original IC design. The primary clock′ is directly connected to the clock input of the clock model, so that glitch is not introducing at the clock input. The frequency of primary clock′ is greater than that of a user clock.

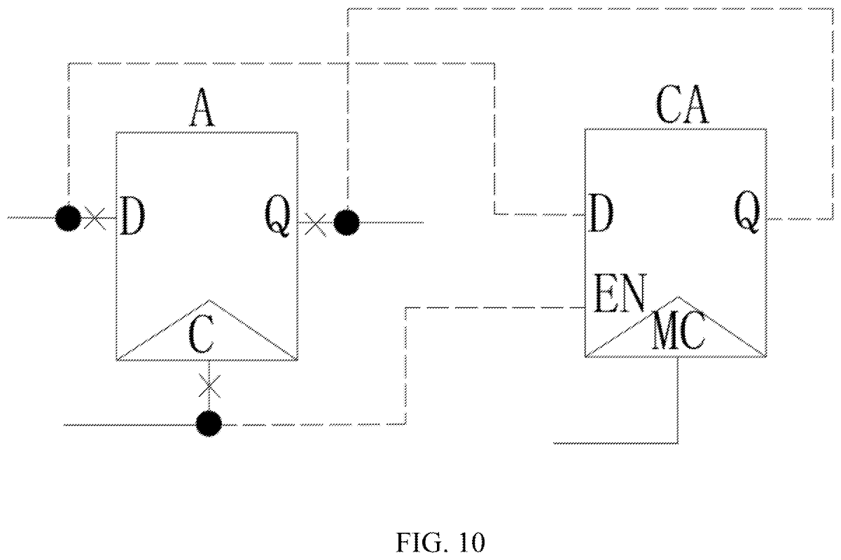

The invention provides two types of clock models, including: clock model_{[CA]} and clock model_{[CB]}. Both of the two types of clock models are driven by coordination of the primary clock′ and the user clock for data sampling to ensure function recurrence of the sequential cells in an IC design. The clock model_{[CA]} emulates the function of sequential cells in an IC design through controlling time of outputting a data sample, and the clock model_{[CB]} emulates the function of sequential cells in IC design through controlling time of sampling data. The ports of the clock model_{[CA]} and the clock model_{[CB]} are the same after package. The substation specific operation is described with only the clock model_{[CA]} for example herein, referring to FIG. 10, it shows structural schematic drawing of sequential cell_{[A]} for which a clock model_{[CA]} is substituted. It should be noted that, the external port of the sequential cell_{[A]} comprises a data input_{[D]}, a user-clock input_{[C]} and a data output_{[Q]}, and the port of the clock model_{[CA]} includes a data input_{[D]}, a user enable_{[Ev]}, a clock input_{[MC]} and a data output_{[Q]}. in FIG. 10, X represents disconnection, and imaginal lines represent wiring after being substituted with a clock model_{[CA]}. especially, a strip of signal line in sequential cell_{[A]} is broken and connected to corresponding port of the clock model_{[CA]}, that is equivalent to modify the corresponding port of the clock model_{[CA]} to the port of the sequential cell_{[A]} and connect corresponding signal line. As shown in FIG. 10, the signal line connected to the user-clock input_{[C]} of the sequential cell_{[A]} is broken and connected to the user enable_{[E]} of the clock model_{[CA]}, that is equivalent to modify the user enable_{[E]} of the clock model_{[CA]} to the user-clock input_{[C]} of the sequential cell_{[A]}, making the user enable_{[E]} of the clock model_{[CA]} connected to a user clock. And so on, the data input_{[D]} of the clock model_{[CA]} is modified to the data input_{[D]} of the sequential cell_{[A]}, making the data input_{[D]} of the clock model_{[CA]} connected to a data input signal; the data output_{[Q]} of the clock model_{[CA]} is modified to the data output_{[Q]} of the sequential cell_{[A]}, making the data output_{[Q]} of the clock model_{[CA]} connected to an output next-level circuit; and the primary clock′ is directly connected to the clock input of clock model_{[CA]}, realizing the purpose of substituting a clock model_{[CA]} for the sequential cell_{[F]}.

The primary clock′ is directly connected to the clock input of the clock model_{[CA]} or the clock model_{[CB]}, there is no combinatorial logic between the primary clock′ and the clock input of the clock model_{[CA]} or the clock input of the clock model_{[CB]}, and no delay is introduced, so that there is no glitch at the clock inputs of the clock model_{[CA]} and the clock model_{[CB]}, solving the glitch problem. The glitch-containing user clock is connected to the clock model_{[CA]} or clock model_{[CB]} through a user enable, and the user enable is insensitive to glitch, so that the data sample of the clock model is not influenced, solving the technical problem. Insensitivity to glitches means: since the user clock of the user enable needs to meet the requirements of setup time and retention time, wherein the setup time refers to the time when the data remains stable until an active edge of primary clock′ arrives, the retention time refers to the time when the data remains stable after the active edge of the primary clock′ arrives, while the glitch has generally short retention time, which cannot meet the requirements of setup time and retention time, and can be shielded, so that the glitch is no longer harmful and will not affect data sampling.

In order to further reduce number of clock domains and save hardware resources in addition to eliminating glitches, the sequential cells in IC design are grouped. The grouping method includes: if a generated clock output from a data output of a sequential cell is connected to a clock input of another sequential cell, the sequential cell is labeled as group A; if a generated clock output from data output of a sequential cell is not connected to a clock input of the other sequential cell_{[A]} but is connected to a data input of the other sequential cell, the sequential cell is labeled as group B. The sequential cells in group A correspond to the sequential cells represented by intermediate nodes of a clock tree, and the sequential cells in group B correspond to the sequential cells represented by leaf nodes of the clock tree.

Clock models_{[CA]} are substituted for all sequential cells in group A. whether the data sample of the clock model_{[CA]} is output is controlled by a user clock_{[A]} but not by a primary clock′, and the clock model_{[CA]} performs data sampling at each active edge of the primary clock′, so that delay does not occur in sampling process and has sampling timing sequence equivalent to sequential cell. Therefore, the clock offsets of the primary clocks' connected to all clock models in group A can be the same, and the clock models_{[CA]} with the same clock offsets of the primary clocks' are in the same clock domain. The primary clocks' in the same clock domain share one clock low-offset buffer (BUFG), thereby greatly reducing clock domains and saving more BUFG resources.

Clock models_{[CB]} are substituted for all sequential cells in group B. The user clocks connected to the user enable of each sequential cell in group B are the data sample output from the data output of the clock models_{[CA]} in group A, respectively. The data sampling time of the clock model_{[CB]} are controlled by both the primary clock′ and the user clock, so that sampling can be performed by waiting that the active edge of the primary clock′ also occurs after an active edge of the user clock of the clock model_{[B]} occurs. The frequency of the primary clock′ connected to the user-clock input of the clock model_{[CB]} is greater than that of the user clock, but not every active edge of the primary clock′ can be sampled. Sampling can be performed only when an active edge of the user clock occurs and an active edge of the primary clock′ occurs, so that is needs to check whether an active edge of the user clock occurs before sampling. The time delay generated during this period makes the data sample obtained by the clock model_{[CB]} is delayed compared to the sampling time of the sequential cell, while the sampling time of the clock model_{[CA]} is equivalent to that of the sequential cell, therefore, the sampling timing of the clock model_{[B]} lags behind that of the clock model_{[CA]}. It should be noted that the clock model_{[CB]} is the clock model with clock delay relative to the clock model_{[CA]}, wherein the clock delay is a delay caused by the hardware structure of the clock model_{[CB]} itself.

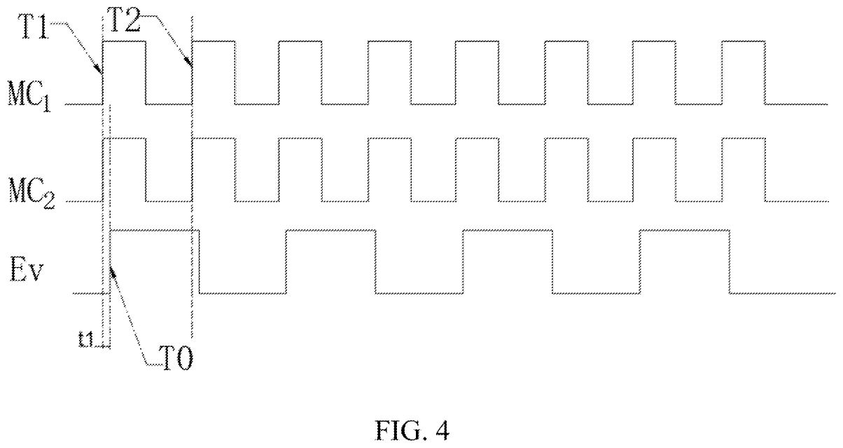

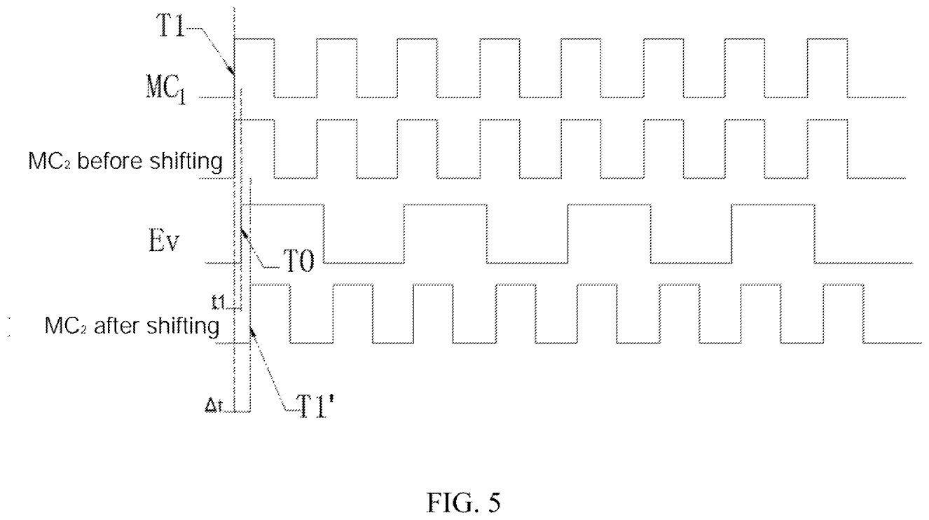

For better understanding, referring to FIG. 4, for distinguishing, MC₁ represents the waveform of the primary clock′ by which the clock model_{[CA]} is driven, MC₂ represents the waveform of the primary clock′ by which the clock model_{[CB]} is driven, Ev represents the waveform of the user clock detected inside the clock model_{[CB]}, and the clock model_{[CA]} is able to be completely equivalent to a sequential cell in timing sequence. In FIG. 4. MC₁ has the first clock active edge occurring time T1 and the second clock active edge occurring time T2. Under normal conditions, if the clock model_{[CB]} and the clock model_{[CA]} can complete a sampling in the same primary clock′ clock period, a correct sampling can be obtained, wherein the time lag between T1 and T2 is a period of the primary clock′. But because the clock model_{[CA]} samples when an active edge of each primary clock′ arrives and outputs the real-time sampling result when an active edge of the user clock arrives, the clock model_{[CB]} samples when it detects the active edge of user clock and waits for the active edge of primary clock′ arrives, the circuit for detecting an active edge of the user clock[Ev] takes a certain amount of time in the detection process, therefore, there is a small time deviation t1 between the occurring time TO of the detected active edge of the user clock[Ev] and the actual occurring time of the active edge of the user clock_{[Ev]}, that is, the occurring time T0 of the detected active edge of the user clock_{[Ev]} is lagged behind the occurring time T1 of the first active edge of MC₂ by a small time deviation t1, as a result, when the first active edge of clock model_{[CB]} is connected to MC₂, the occurrence of an active edge in the user clock_{[Ev]} cannot be detected, so that the correct sampling cannot be performed when the first active edge of primary clock′ occurs, it is therefore not possible to sample correctly when the first active edge of the primary clock′ occurs and samples by waiting for the occurring time T2 of a second active edge of the primary clock′ during the occurrence of an active edge in the user clock_{[Ev]}. As a result, the clock model_{[CB]} samples at time T2, while the clock model_{[CA]} samples at time T1, and the sampling timing sequence of the clock model_{[CB]} is just one clock period of the primary clock′ lagged behind the clock model_{[CA]}. The lagged clock period causes timing sequence disorder. In order to make the clock model_{[CB]} and the clock model_{[CA]} perform data sampling in the same period, referring to FIG. 5, the primary clock′ by which the clock model_{[CB]} is driven should be actively shifted forward by an offset time Δt, which is greater than the time offset t1 and smaller than the clock period of the primary clock′. FIG. 5 shows comparison of the MC₂ waveform before shifting and the MC₂ waveform after shifting. The occurring time T1′ at a first active edge in the MC₂ waveform after shifting is lagged behind the occurring time T0 at an active edge of the user clock, that is, after the active edge of the user clock occurs, the first active edge in the shifted MC₂ waveform occurs, so that the data sampling time is advanced to the occurring time T1′ at the first active edge in the MC₂ waveform after shifting, and T1′ and the occurring time T1 at the first clock active edge are in the same period of the primary clock′, thereby obtaining correct data sample.

In order to make the clock model_{[CB]} and the clock model_{[CA]} as parent node complete sampling in the same period of the same primary clock′ and ensure that the sampling timing sequence is not disordered, it is necessary to configure the triggering time of the active edge of the primary clocks' by which all clock models_{[CB]} are driven to be actively lagged behind that of the active edge of the primary clocks' by which the clock models_{[CA]} are driven as parent node in the same period, therefore, each clock model_{[B]} and the clock model_{[CA]} as parent node satisfy: TB=TA+Δt, wherein TB is the sampling time of the primary clock′ of the clock model_{[CB]}. TA is the sampling time of the primary clock′ by which the clock model_{[CA]} is driven, and Δt is clock offset. The parent nodes of different clock models_{[CB]} in group B can be different, resulting in different clock offsets of clock models_{[CB]} driven the primary clocks' in group B and then resulting in a large increase on number of the clock domains.

Further, in order to reduce number of the clock domains, all clock models_{[CB]} in group B are driven the same one primary clock′, and the clock offsets Δt of the primary clocks' are the same, that is, all clock models_{[CB]} in group B are driven by a primary clock′, all clock models_{[CA]} in group A are driven by a primary clock′, and the two primary clocks' satisfy: TB=TA+Δt, and Δt satisfies: a minimum threshold<Δt<a clock period of the primary clock′, wherein, the minimum threshold is a maximum of delays across the user clocks_{[B]} connected to the clock models_{[CB]} for replacing the plurality of sequential cells being labeled as group B. All clock models_{[CB]} in group B are located in the same time domain in the method, saving BUFG resources.

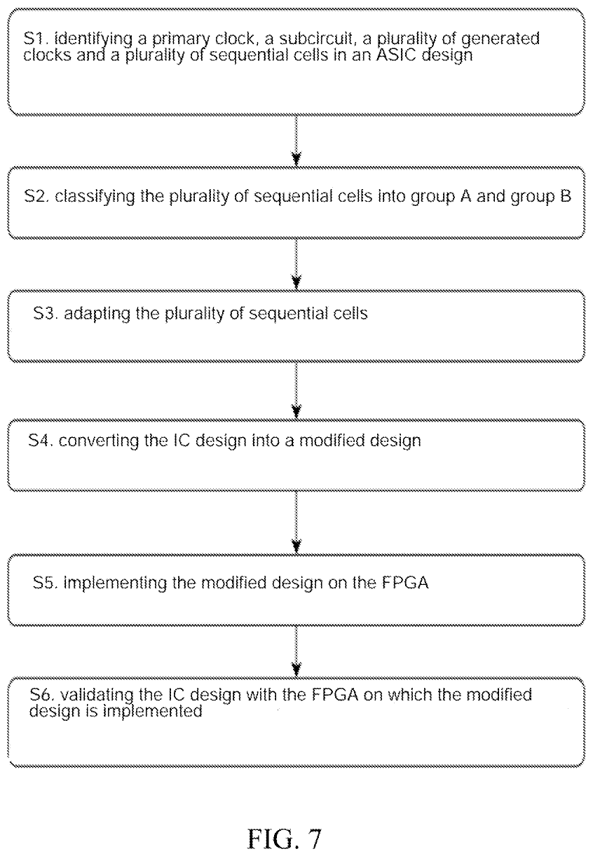

Referring to FIG. 7, a method for emulating an IC design with an FPGA proposed by the present invention is described in detail. The method comprises the steps of:

S1) identifying in the IC design: a primary clock, a subcircuit, a plurality of generated clocks and a plurality of sequential cells, wherein the plurality of generated clocks are derived from the primary clock after being processed by the subcircuit, and a user clock being connected to one of the plurality of sequential cells is the primary clock or one of the plurality of generated clocks.

Preferably, the primary clock is a clock input source of an IC design, and usually represents a physical clock.

Preferably, the subcircuit is a combinational logic circuit, a sequential logic circuit or hybrid circuit of a combinational logic circuit and a sequential logic circuit. As an example, the subcircuit can be a frequency divider, a gate clock or a multiplexer, wherein the frequency divider is a sequential logic circuit, and the gate clock and the multiplexer are combinational logic circuits.

Wherein, the generated clocks are derived from the primary clock or a previous-level generated clock after being processed by the subcircuit. Different generated clocks are derived from the primary clock by being processed by different subcircuits, and next-level generated clocks can be also derived from the generated clocks after being processed by another subcircuit, and so on, the primary clock and the topological structure of the generated clocks form a clock tree structure. The generated clocks are used to be connected to the clock inputs of a plurality of sequential cells or be connected to the data inputs of the sequential cells to drive the sequential cells for data sampling.

Wherein, the sequential cell comprises a user-clock input, a data input and a data output. When an active edge is occurring on a user clock connected to the user-clock input, the sequential cell is triggered to sample data signal from the data input, and data sample is output by the data output. The active edge of the user clock is used as driving signal to drive the sequential cell for sampling. Under the action of the driving signal, the data input to the sequential cell is sampled and output to obtain the generated clocks. The data sample output from the data output of a sequential cell can be used as clock input signal of the clock input of another sequential cell, and can also be used as data input signal of the data input of another sequential cell.

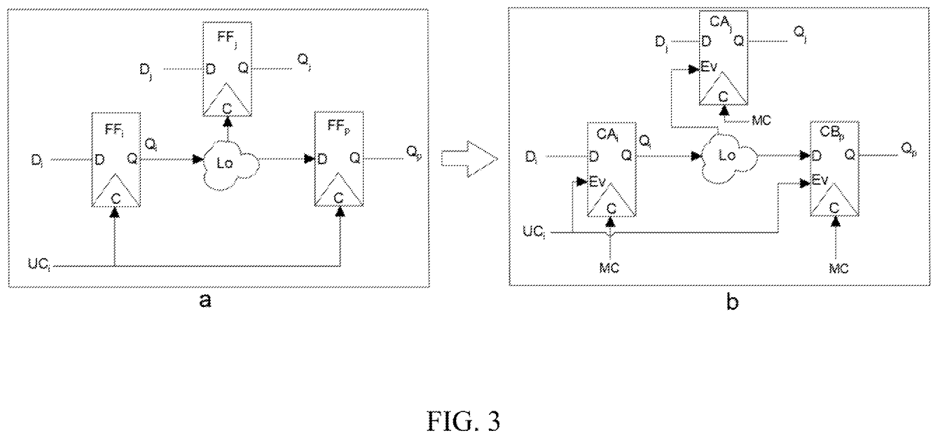

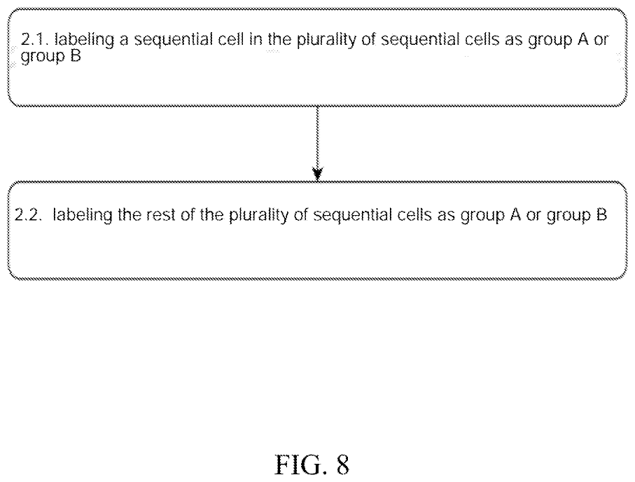

Preferably, the sequential cell is configured to be a latch, a trigger, a register, a shifting register or a memory. Other combined units having the same function in prior art fall within the protection scope of the prevent invention.

Wherein, the sequential cells are connected by cascade connection or series connection, referring to FIG. 3. In FIG. 3, the part a is possible connection structure among sequential cells in an IC design, wherein, each sequential cell includes a data input_{[D]}, a clock input_{[C]} and a data output_{[Q]}, the cascade connection is that the data signal_{[Qi]} output from the data output_{[Q]} of the i-th sequential cell_{[FFi]} is connected to the clock input_{[C]} of the j-th sequential cell, and the serial connection is that the data signal_{[Qi]} output from the data output_{[Q]} of the i-th sequential cell_{[FFi]} is connected to the data input_{[D]} of the p-th sequential cell.
S2) classifying the plurality of sequential cells into group A or group B. Referring to FIG. 8, S2) includes: 2.1) labeling a sequential cell in the plurality of sequential cells as group A or group B, and 2.2) labeling the rest of sequential cells in the plurality of sequential cells as group A or group B.

Wherein, S2.1) includes: identifying on the one sequential cell: a user clock by which the sequential cell is driven, a data input, a user-clock input and a data output, wherein the user clock is connected the user-clock input; 2.1.2) labeling the sequential cell_{[A]} as group A if the data output is connected to a user-clock input of another sequential cell; and 2.1.3) labeling the sequential cell_{[A]} as group B if the data output is not connected to a user-clock input of the other sequential cell_{[A]} and is connected to a data input of the other sequential cell.

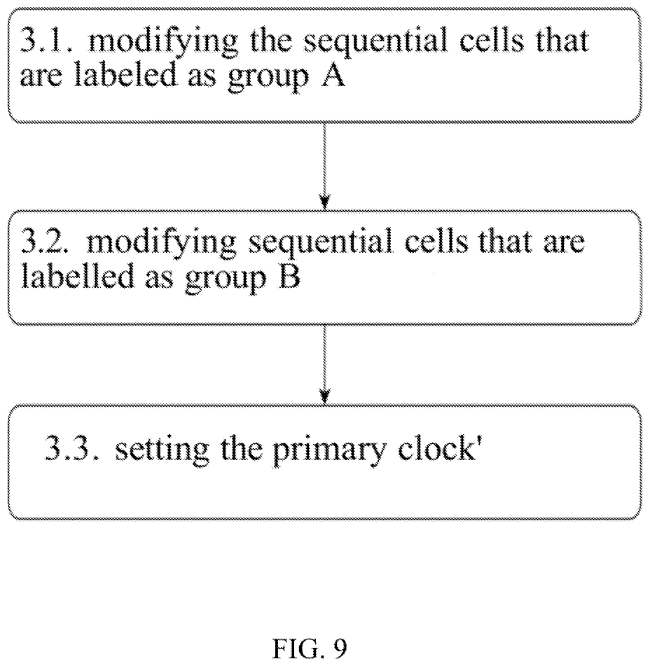

As an example, referring to FIG. 3, in the part a of FIG. 3, when the data output_{[Q]} of the sequential cell_{[FFi]} is connected to the data input_{[D]} of sequential cell_{[FFp]} and the clock input_{[C]} of sequential cell_{[FFj]} simultaneously, the sequential cell_{[FFi]} satisfies the condition to be labelled as group A but does not satisfy the condition to be labelled as group B, so that the sequential cell_{[FFj]} is labelled as group A.
S3) modifying the plurality of sequential cells. Referring to FIG. 9. S3 includes: 3.1) modifying the sequential cells that are labeled as group A; 3.2) modifying sequential cells that are labelled as group B; and 3.3) configuring the primary clock′.

Specifically, 3.1) includes: 3.1.1) configuring a clock model_{[CA]}, which includes a data input_{[CA]}, a data output_{[CA]}, a user enable_{[CA]} and a clock input_{[CA]}; 3.1.2) modifying a sequential cell_{[A]} in the a plurality of sequential cells being labelled as group A, including: i) identifying in view of S2: a user clock_{[A]} by which the sequential cell_{[A]} is driven, a data input_{[A]}, a user-clock input_{[A]} and a data output_{[A]}, wherein the user clock_{[A]} is connected to the user-clock input_{[A]}; ii) substituting the clock model_{[CA]} for the sequential cell_{[A]}, including: connecting the data input_{[CA]} to what was connected to the data input_{[A]}, connecting the data output_{[CA]} to what was connected to the data output_{[A]}, connecting the user enable_{[CA]} to what was connected to the user-clock input_{[A]}, and connecting the clock input_{[CA]} to a primary clock′, wherein: the primary clock′ is equal to or greater than the primary clock in frequencies; iii) configuring the clock model_{[CA]}, including: sampling a signal from the data input_{[CA]} at an active edge of the primary clock′ to obtain a data sample for a period of the primary clock′ led by the active edge, when an N-th active edge is occurring on the user clock_{[A]}: obtaining a data sample_{[N]} for a contemporary period of the primary clock′; and outputting to the data output_{[CA]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′; and outputting to the data output_{[CA]} the data sample_{[N+1]} until an N+2-th active edge occurs on the user clock_{[A]}.

The internal structures of clock models_{[CA]} include various structure types, and the embodiment of the invention provides the following three deformation structures. The models in the prior art that can realize the same function as the clock models_{[CA]} also fall within the protection scope of the present invention.

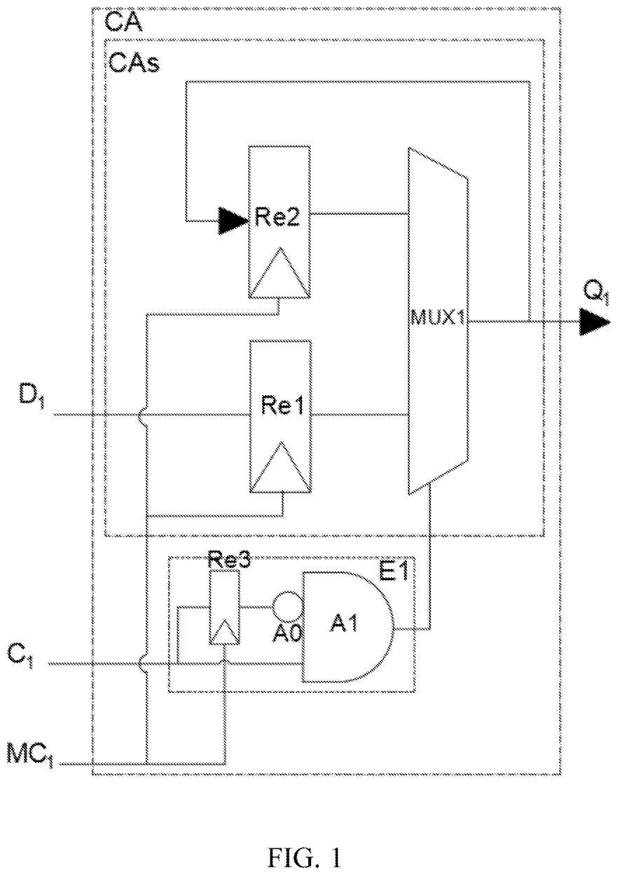

Preferably, referring to FIG. 1 again, the clock model_{[CA]} includes a clock detector_{[E1]} and a sampler_{[CAs]}. As shown in FIG. 1, D₁ represents data signal connected to the clock input_{[CA]}, C₁ represents the user clock_{[A]} connected to the user enable_{[CA]}, MC₁ represents the primary clock′ connected to the clock input_{[CA]}, Q₁ represents the data signal output from the data output_{[CA]}. Namely, The user enable_{[E1]} is connected to C₁, the clock input_{[E1]} is connected to MC₁, the active-edge output of E1 is connected to enable_{[CAs]}, the data input_{[CA]} is connected with D₁, and the data output_{[CAs]} is connected with Q₁. Wherein, S3.1 further includes: configuring for the clock model_{[CA]} a clock detector_{[E1]} and a sampler_{[CAs]}; configuring for the clock detector_{[E1]} a user enable_{[E1]}, a clock input_{[E1]} and an active-edge output_{[E1]}; configuring for the sampler_{[CAs]} a data input_{[CAs]}, an enable_{[CAs]}, a clock input_{[CAs]} and a data output_{[CAs]}; connecting the user enable_{[E1]} to the user enable_{[CA]}; connecting the clock input_{[E1]} and the clock input_{[CAs]} to the clock input_{[CA]}; connecting the active-edge output_{[E1]} to the enable_{[CAs]}; connecting the data input_{[CAs]} to the data input_{[CA]}; and connecting the data output_{[CAs]} to the data output_{[CA]}, wherein, the clock detector_{[E1]} is used for detecting whether active edge occurs or not; the sampler_{[CAs]} is used for sampling signals from the data input_{[CA]} at each active edge of the primary clock′ to obtain data sample for a period of the primary clock′ led by the active edge; when an N-th active edge is occurring on the user clock_{[A]}: obtaining a data sample_{[N]} for a contemporary period of the primary clock′; and outputting to the data output_{[A]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′; and outputting to the data output_{[CA]} the data sample_{[N+1]} until an N+2-th active edge occurs on the user clock_{[A]}, wherein the active edge of the user clock output by the clock detector_{[E1]} is used for driving the sampler_{[CAs]} to output corresponding data sample.

Preferably, as shown in FIG. 1, S3.1 further includes: configuring for the sampler_{[CAs]} a first state holder_{[Re1]}, a second state holder_{[Re2]} and a multiplexer_{[MUX1]}; configuring for the first state holder_{[Re1]} a clock input_{[Re1]}, a data input_{[Re1]} and a data output_{[Re1]}; configuring for the second state holder_{[Re2]} a clock input_{[Re2]}, a data input_{[Re2]} and a data output_{[Re2]}; configuring for the multiplexer_{[MUX1]} a first data input_{[MUX1]}, a second data input_{[MUX1]}, a signal selection_{[MUX1]} and a data output_{[MUX1]}; connecting the data input_{[Re1]} to the data input_{[CAs]}; connecting the data output_{[MUX1]} to the data output_{[CAs]}; connecting the clock input_{[Re1]} and the clock input_{[Re2]} to the clock input_{[CAs]}; connecting the data output_{[Re1]} to the first data input_{[MUX1]}; connecting the data input_{[Re2]} to the data output_{[MUX1]}; connecting the data output_{[Re2]} to the second data input_{[MUX1]}; and connecting the enable_{[CAs]} to the signal selection_{[MUX1]}. The structure of the sampler_{[CAs]} can not only realize the same function as the sequential cell by controlling the time of outputting the data sample, but also achieves no delay in the sampling process of the sampler_{[CAs]} since its internal structure samples at each active edge of the primary clock′, and has timing sequence equivalent to the sequential cell in an IC design.

Wherein, the multiplexer is configured to be a combinational logic circuit with a plurality of data inputs and single data output. The multiplexer with a plurality of data inputs is a multi-channel digital switch, and can select one data input signal from the plurality of data inputs according to different signals of a signal selection and output to a common data output.

Wherein, the first state holder_{[Re1]} is used for realizing sampling of data signal from the data input_{[CA]} when each active edge of the primary clock′ occurs to obtain data sample. The second state holder_{[Re2]} is used for realizing sampling of data signal from the data input_{[CA]} when each active edge of the primary clock′ occurs to obtain data sample, wherein the primary clock′ is greater than the user clock in clock frequencies, and the first state holder_{[Re1]} and the second state holder_{[Re2]} are connected to the same one primary clock′. Two kinds of data samples are obtained at each active edge of the primary clock′, including: the data sample obtained at contemporary period of the primary clock′ and outputted from the first state holder_{[Re1]}, and the data sample obtained at previous one period of the primary clock′ and outputted from the second state holder_{[Re2]}. The multiplexer_{[MUX1]} is used for selectively outputting the data sample of first state holder_{[Re1]} when the user clock_{[A]} is active and outputting the data sample of the second state holder_{[Re2]} when the user clock_{[A]} is inactive. That is, when the i-th active edge of primary clock′ arrives, the first state holder_{[Re1]} samples the input data to obtain data sample 1, if the user clock_{[A]} is active at this time, and the multiplexer_{[MUX1]} is driven to select the data sample of the first state holder_{[Re1]} to output the data 1; when the (i+1)-th active edge of primary clock′ arrives, the first state holder_{[Re1]} continues to sample the input data to obtain the new data sample 2, but at this time the second state holder_{[Re2]} samples the data 1 output by the multiplexer_{[MUX1]} to obtain data 1, if the user clock_{[A]} is inactive at this time, the multiplexer_{[MUX1]} is driven to select the data sample of the second state holder_{[Re2]} to output data 1, and when the (i+2)-th active edge of primary clock′ arrives, if the user clock is active, the multiplexer_{[MUX1]} is driven to output the new data sample 2, otherwise continue to output data 1, so as to achieve that: when the N-th active edge is occurring on the user clock_{[A]}: the data sample N of the primary clock′ in the contemporary period is obtained and output to the data output_{[CA]} until the (N+1)-th active edge is occurring on the user clock_{[A]}; and when the (N+1)-th active edge is occurring on the user clock_{[A]}: the data sample N+1 of the primary clock′ in the contemporary period is obtained and output to the data output_{[CA]} until the (N+2)-th active edge is occurring on the user clock_{[A]}.

Further, preferably, referring to FIG. 1 again, a clock detector_{[E1]} is configured for a third state holder_{[Re3]}, a non-gate circuit_{[A]} and an AND gate circuit_{[A1]}, including: configuring for the third state holder_{[Re3]} a clock input_{[Re3]}, a data input_{[Re3]} and a data output_{[Re3]}; configuring for the non-gate circuit a signal input_{[A0]} and a signal output_{[A0]}; configuring for the AND gate circuit a first data input_{[A1]}, a second data input_{[A]} and a data output_{[A1]}; connecting the clock input_{[Re3]} to the clock input_{[E1]}; connecting the data input_{[Re3]} and the first data input_{[A1]} to the user enable_{[E1]}; connecting the data output_{[Re3]} to the signal output_{[A0]}; connecting the signal output_{[A0]} to second data input_{[A1]}; and connecting the data output_{[A1]} to an active-edge output_{[E1]}.

Wherein, the gate circuit_{[A]} is used for realizing that logic output from the signal output_{[A]} is opposite to that output from the signal input_{[A0]}. The AND gate circuit_{[A1]} is used for realizing that: the data output_{[A1]} outputs high logic when the first data input_{[A1]} and the second data input_{[A1]} are at high logic state simultaneously, otherwise, the data output_{[A1]} outputs low logic.

Preferably, the combinational circuit of the non-gate circuit_{[A1]} and the AND gate circuit_{[A1]} can comprise lookup tables with the same truth table, wherein the digital combinational circuit realizing lookup tables with the same truth table comprises various types, wherein the lookup table is a structure used to implement the truth table that has written all possible logical combinations and their corresponding logical results in advance. The corresponding logical results can be obtained according to the logical combinations at the input of the lookup table.

Circuits in the prior art that can achieve the same function as the clock detector_{[E1]} fall into the protection scope of the present invention. The same function refers to the function of clock edge detection. The clock detector can be configured to be a clock detector for detecting a rising edge, a clock detector for detecting a falling edge or a clock detector for detecting double edges.

The clock model_{[CA]} can not only reproduce the function of the sequential cell, but also directly performs data sampling after an active edge of the primary clock arrives owing to its internal structure, and only selectively outputs the corresponding sampling results, so that there is no delay problem on the sampling time of the clock model_{[CA]}.

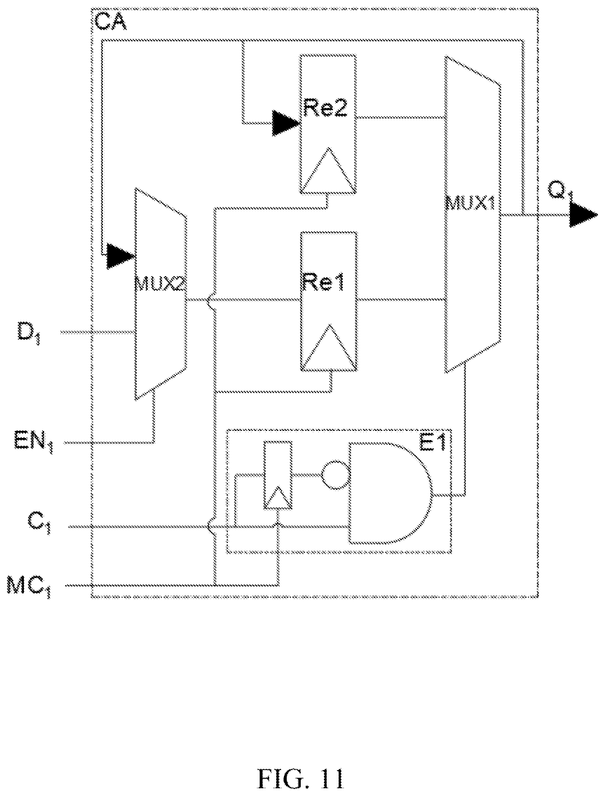

Preferably, when an enable of a sequential cell is connected to a circuit, referring to FIG. 11, the clock model_{[CA]} also has an enable. Specifically, D₁ represents data signal of the data input_{[CA]}, Q₁ represents the data sample output from the data output_{[CA]}, C₁ represents the user clock connected to the user enable_{[CA]}, MC₁ represents the clock signal connected to the clock input_{[CA]}, EN₁ represents the enable signal connected to the enable_{[CA]}. S2.1 further includes identifying on the sequential cell, a data input, a user-clock input, a data output and an enable. S3.1 further includes configuring for the clock model_{[CA]} a data input_{[CA]}, a data output_{[A]}, a user enable_{[CA]}, a clock input_{[CA]} and an enable_{[CA]}; configuring for the clock model_{[CA]} a clock detector_{[E1]}, a first state holder_{[Re1]}, a second state holder_{[Re2]}, a multiplexer_{[MUX1]} and a multiplexer_{[MUX2]}; configuring for the clock detector_{[E1]} a user enable_{[E1]}, a clock input_{[E1]} and an active-edge output_{[E1]}; configuring for the first state holder_{[Re1]} a clock input_{[Re1]}, a data input_{[Re1]} and a data output_{[Re1]}; configuring for the second state holder_{[Re2]} a clock input_{[Re2]}, a data input_{[Re2]} and a data output_{[Re2]}; configuring for the multiplexer_{[MUX1]} a first data input_{[MUX1]}, a second data input_{[MUX1]}, a signal selection_{[MUX1]} and a data output_{[MUX1]}; configuring for the multiplexer_{[MUX2]} a first data input_{[MUX2]}, a second data input_{[MUX2]}, a signal selection_{[MUX2]} and a data output_{[MUX2]}; connecting the second data input_{[MUX2]} to the data input_{[CA]}; connecting the data output_{[MUX1]} to the data output_{[CA]}, the data input_{[Re2]} and the first data input_{[MUX2]}; connecting the second data input_{[MUX2]} to the data input_{[CA]}; connecting the data output terminal_{[MUX1]} to the data output_{[CA]}, the data input_{[Re2]} and the first data input_{[MUX2]}; connecting the clock input_{[Re1]}, the clock input_{[Re2]} and the clock input_{[E1]} to the clock input_{[CA]}; connecting the user enable_{[E1]} to the user enable_{[CA]}; connecting the active-edge output_{[E1]} to the signal selection_{[MUX1]}; connecting the data output_{[Re2]} to the second data input_{[MUX1]}; connecting the enable_{[CA]} to the signal selection_{[MUX2]}; connecting the data output_{[MUX2]} to the data input_{[Re1]}; and connecting the data output_{[Re1]} to the first data input_{[MUX1]}. It should be noted that, when the enable signal assessed to the enable_{[CA]} is active, the multiplexer_{[MUX2]} is used to realizing that: the multiplexer_{[MUX2]} is driven to selectively output data signal_{[D1]} input by the data input_{[CA]} to the data input_{[Re1]}; otherwise, is driven to selectively output the data signal_{[Q1]} output by the data output_{[CA]} to the data input_{[Re1]}.

Preferably, the first state holder_{[Re1]} is configured to be a register or a latch, and the second state holder_{[Re2]} is configured to be a register or a latch.
3.2) sequential cells which are labelled as group B are modified, including: 3.2.1) configuring a clock model_{[CB]}, which includes a data input_{[CB]}, a data output_{[CB]}, a user enable_{[CB]} and a clock input_{[CB]}; 3.2.2) modifying a sequential cell_{[B]} in the plurality of sequential cells being labelled as group B, including: i) identifying in view of S2: a user clock_{[B]} by which the sequential cell_{[B]} is driven, a data input_{[B]}, a user-clock input_{[B]} and a data output_{[B]}, wherein the user clock_{[B]} is connected to the user-clock input_{[B]}; ii) substituting the clock model_{[CB]} for the sequential cell_{[B]}, including: connecting the data input_{[CB]} to what was connected to the data input_{[B]}, connecting the data output_{[B]} to what was connected to the data output_{[B]}, connecting the user enable_{[CB]} to what was connected to the user-clock input_{[B]}, and connecting the clock input_{[C]} to a primary clock′; and iii) configuring the clock model_{[CB]}, including: when an active edge is occurring on the user clock_{[B]} and when an active edge is occurring on the primary clock′: sampling a signal from the data input_{[CB]} to obtain a data sample for a period of the primary clock′ led by the active edge on the primary clock′; and outputting to the data output_{[CB]} the data sample; and when no active edge occurs on the user clock_{[B]} or no active edge occurs on the primary clock′: sampling nothing from the data input_{[CB]}; and outputting nothing to the data output_{[CB]}; and 3.2.3) modifying the rest of sequential cells in the sequential cells which are labelled as group B.

The primary clock′ is directly connected to the clock input_{[CB]} of the clock model_{[CB]}, the glitch-containing user clock is connected to the user enable_{[CB]} of the clock model_{[CB]}, the clock model_{[CB]} and the clock model_{[CB]} have the same principle of solving technical problem, there is no glitch in the primary clock′ connected to the clock input_{[CB]}, the glitch-containing user clock is connected to the glitch-insensitive user enable_{[CB]}, and the glitch does not affect data sampling, so that the clock model_{[CB]} solves the glitch problem.

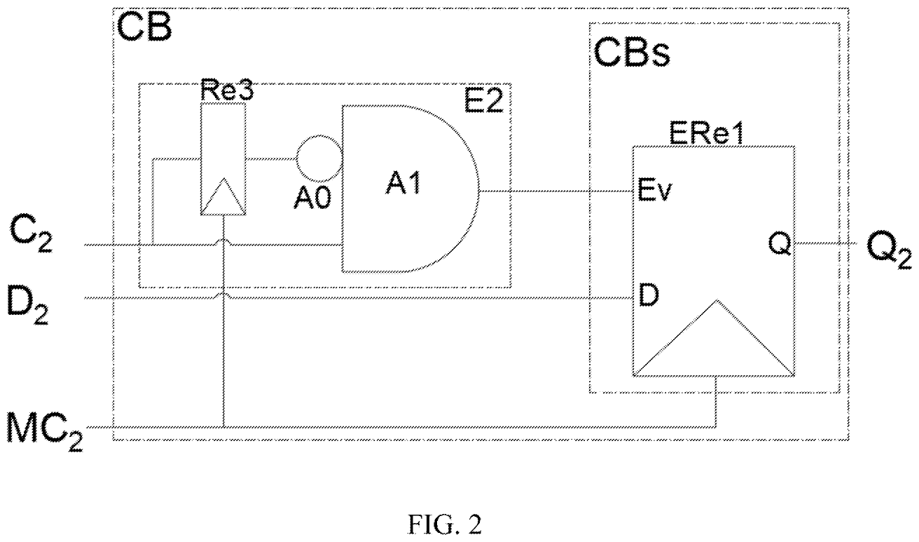

Preferably, referring to FIG. 2, S3.2 further includes: configuring for the clock model_{[CB]} a clock detector_{[E2]} and a sampler_{[CBs]}; configuring for the clock detector_{[E2]} a user enable_{[E2]}, a clock input_{[E2]} and an active-edge output_{[E2]}; configuring for the sampler_{[CBs]} a clock input_{[CBs]}, an enable_{[CBs]}, a data input_{[CBs]} and a data output_{[CBs]}; connecting the data input_{[CBs]} to the data input_{[CB]}; connecting the data output_{[CBs]} to the data output_{[CB]}; connecting the clock input_{[E2]} and the clock input_{[CBs]} to the clock input_{[CB]}; connecting the user enable_{[E2]} to the user enable_{[CB]}; and connecting the active-edge output_{[E2]} to the enable_{[CBs]}.

The function of the clock detector_{[E2]} is the same as that of the clock detector_{[E1]}, the internal structure of the clock detector_{[E2]} is the same as that of the clock detector_{[E1]}, and here detailed description is avoided.

Wherein, the sampler_{[CBs]} is used for sampling a signal from the data input_{[CB]} when an active edge is occurring on the user clock_{[B]} and the active edge is occurring on the primary clock′ to obtain a data sample for a period of the primary clock′ led by the active edge on the primary clock′, and outputting to the data output_{[B]} the data sample; and when no active edge occurs on the user clock_{[B]} or no active edge occurs on the primary clock′: sampling nothing from the data input_{[CB]}, and outputting nothing to the data output_{[CB]}.

Circuits for realizing the sampler CBs can be configured to be various types. The examples in the present invention provide two deformation methods.

Preferably, the sampler_{[CBs]} is configured to be a register_{[ERe1]} having an enable. The clock model_{[CB]} has simple internal structure, and the clock model_{[CA]} is realized by combination of more hardware. Compared with the clock model_{[CA]}, the clock model_{[CB]} can save a lot of hardware resources, so that the clock model_{[CA]} and the clock model_{[CB]} are cooperated to realize balance of hardware resources.

Preferably, referring to FIG. 2 again, the clock model_{[CB]} includes a register_{[ERe1]} and a clock detector_{[E2]}, wherein the register_{[ERe1]} is configured to be a register having an enable, and the output of the clock detector is connected to the enable of the register.

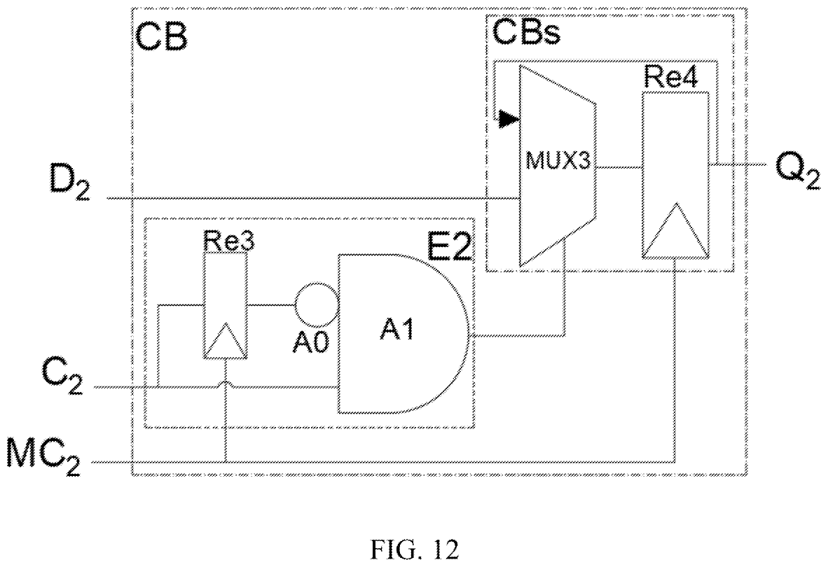

Preferably, referring to FIG. 12, the steps include: configuring for the sampler_{[CBs]} a fourth state holder_{[Re4]} and a multiplexer_{[MUX3]}; configuring for the fourth state holder_{[Re4]} a clock input_{[Re4]}, a data input_{[Re4]} and a data output_{[Re4]}; configuring for the multiplexer_{[MUX3]} a first data input_{[MUX3]}, a second data input_{[MUX3]}, a signal selection_{[MUX3]} and a data output_{[MUX3]}; connecting the first data input_{[MUX3]} to the data input_{[CBs]}; connecting the data output_{[Re4]} to the second data input_{[MUX3]} and to the data output_{[CBs]}; connecting the clock input_{[Re4]} to the clock input_{[CBs]}; connecting the signal selection_{[MUX3]} to the enable_{[CBs]}; and connecting the data output_{[MUX3]} to the data input_{[Re4]}. The combined function of the multiplexer_{[MUX3]} and the fourth state holder_{[Re4]} is equivalent to the function of the register_{[ERe1]} having an enable. The multiplexer_{[MUX3]} is used for selecting the data signal input by the data input_{[CBs]} when the user signal is active to output to the fourth state holder_{[Re4]}, otherwise, selecting the data signal output from the data output_{[CBs]} to output to the fourth state holder_{[Re4]}, and sampling the data signal from the data input_{[Re4]} when the primary clock′ is active to output. It should be noted that, the clock model_{[CB]} is a clock model having clock delay relative to the clock model_{[CA]}, and the clock delay of the clock model_{[CB]} is delay caused by the hardware structure of the clock model_{[CB]} itself.

Preferably, the fourth state holder_{[Re4]} is configured to be a register or a latch.

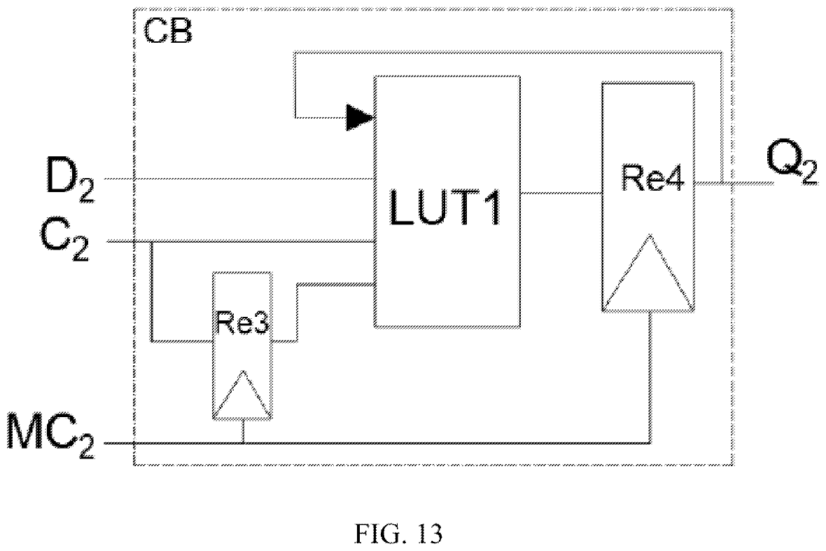

Preferably, the clock model_{[CB]} also can be functional module composed of other structures, referring to FIG. 13, configuring for the clock model_{[CB]} a third state holder_{[Re3]}, a fourth state holder_{[Re4]} and a lookup table_{[LUT1]}; configuring for the third state holder_{[Re3]} a clock input_{[Re3]}, a data input_{[Re3]} and a data output_{[Re3]}; configuring for the fourth state holder_{[Re4]} a clock input_{[Re4]}, a data input_{[Re4]} and a data output_{[Re4]}; configuring for the lookup table_{[LUT1]} a first data input_{[LUT1]}, a second data input_{[LUT1]}, a third data input_{[LUT1]}, a fourth data input_{[LUT1]} and a data output_{[LUT1]}; connecting the second data input_{[LUT1]} to the data input_{[CB]}; connecting the data output_{[Re4]} to the first data input_{[LUT1]} and the data output_{[CB]}; connecting the clock input_{[Re3]} and the clock input_{[Re4]} to the clock input_{[CB]}; connecting the data input_{[Re3]} and the third data input_{[LUT1]} to the user enable_{[CB]}; connecting the data output_{[Re3]} to the fourth data input_{[LUT1]}; and connecting the data output_{[LUT1]} to the data input_{[Re4]}. It should be noted that, the function of the lookup table_{[LUT1]} is equivalent to that of the non-gate circuit_{[A0]} in FIG. 12, and an AND gate circuit_{[A1]} and a multiplexer_{[MUX3]} have a combined function of a module. The first to fourth data inputs of the lookup table_{[LUT1]} are equivalent to the signal input_{[A0]}, the first data input_{[A1]}, the first data input_{[MUX3]} and the second data input_{[MUX3]}. The data output_{[LUT1]} of the lookup table_{[LUT1]} is equivalent to the data output_{[Re4]} in FIG. 12, that is, the function of pre-written truth table of the lookup table_{[LUT1]} is equivalent to the combined function of the AND gate circuit_{[A1]} and the multiplexer_{[MUX3]}.

The third state holder_{[Re3]} is configured to be a register or a latch.

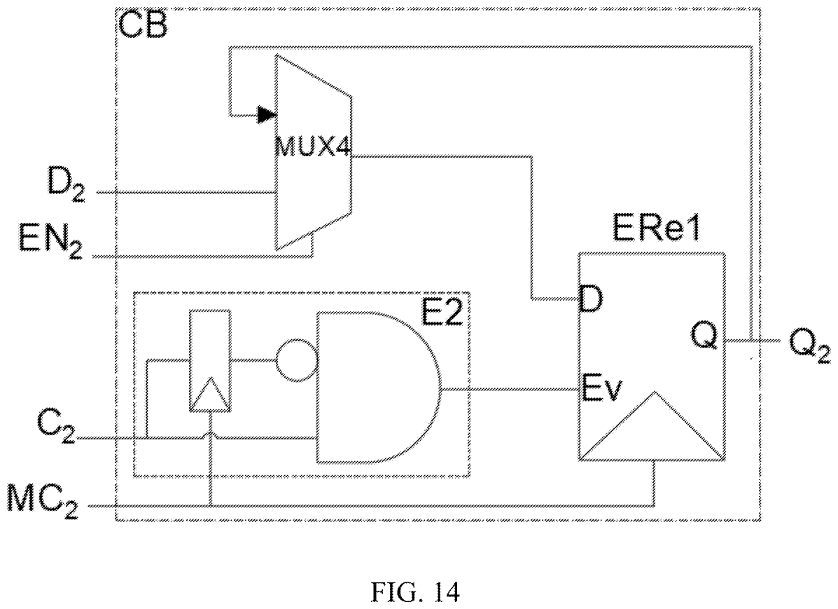

Preferably, when an enable of a sequential cell is connected to a circuit, referring to the FIG. 14, S2.1 further includes: identifying on the sequential cell: a data input, a user-clock input, a data output and an enable. S3.2 further includes: configuring for the clock model_{[CB]} a data input_{[CB]}, a data output_{[CB]}, a user enable_{[CB]}, a clock input_{[CB]} and an enable_{[CB]}; configuring for the clock model_{[CB]} a clock detector_{[E2]}, a memory cell_{[ERe1]} and a multiplexer_{[MUX4]}; configuring for the clock detector_{[E2]} a user enable_{[E2]}, a clock input_{[E2]} and an active-edge output_{[E2]}; configuring for the memory cell_{[ERe1]} a clock input_{[ERe1]}, an enable_{[ERe1]}, a data input_{[ERe1]} and a data output_{[ERe1]}; configuring for the multiplexer_{[MUX4]} a first data input_{[MUX4]}, a second data input_{[MUX4]}, a signal selection_{[MUX4]} and a data output_{[MUX4]}; connecting the second data input_{[MUX4]} to the data input_{[CB]}; connecting the signal selection_{[MUX4]} to the enable_{[CB]}; connecting the data output_{[ERe1]} to the data output_{[CB]} and to the first data input_{[MUX4]}; connecting the clock input_{[E2]} and the clock input_{[ERe1]} to the clock input_{[CB]}; connecting the user enable_{[E2]} to the user enable_{[CB]}; connecting the active-edge output_{[E2]} to the enable_{[ERe1]}; and connecting the data output_{[MUX4]} to the data input_{[ERe1]}. In FIG. 14, D₂ represents a data signal connected to the data input_{[CB]}, Q₂ represents the data sample output from the data output_{[CB]}, C₂ represents the user clock connected to the user enable_{[CB]}, MC₂ represents a clock signal connected to the clock input_{[CB]}, and EN₂ represents the enable signal connected to the enable_{[CB]}. It should be noted that, when the enable signal connected to the enable_{[CB]} is active, the multiplexer_{[MUX4]} is driven to output the data signal_{[D2]} input by the data input_{[CB]} to the data input_{[ERe1]}, otherwise, the multiplexer_{[MUX4]} is driven to output the data signal_{[Q2]} output from the data output_{[CB]} to the data input_{[ERe1]}. Preferably, an active edge is configured to a rising edge or falling edge, wherein, the active edge is the active edge triggered by the user clock and/or the active edge triggered by the primary clock′.

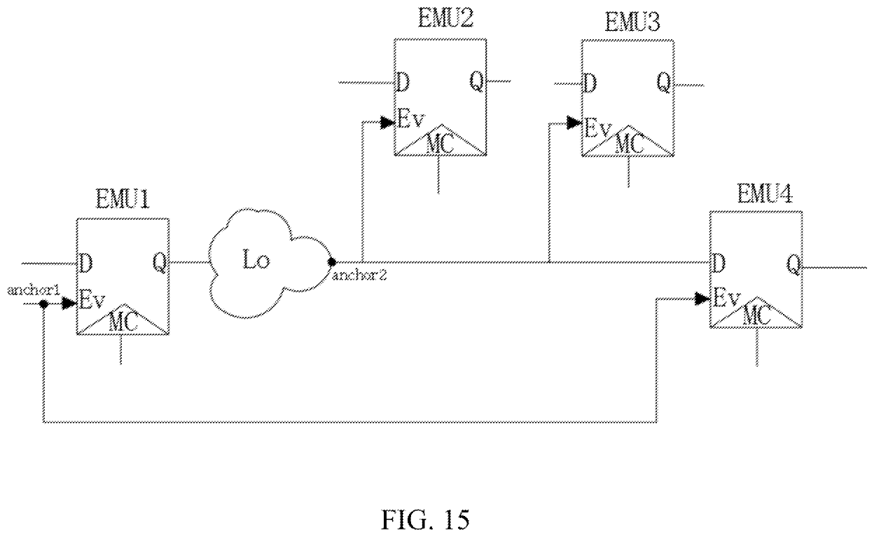

In an IC design, there are anchor points in the combinational logics among sequential cells. The anchor point is the generated clock, which is output by the sequential cell, processed by the combinational logic circuit and then processed by a plurality of branch output ports, and each branch output port is called as an anchor point, and each anchor point is connected to the clock input of the corresponding clock model. Since the user clocks connected to the same anchor point are exactly the same, the results of the user clock active edges of the same user clock output through the clock detector of different clock models are the same, thereby saving hardware resources. The clock models connected to the same anchor point are configured to share a same clock detector to detect an active edge of a user clock. As an example, in order to better understand the anchor point in the present invention, referring to FIG. 15, four modified clock models_{[EMU1-[EMU4]} are provided in FIG. 15. The clock models_{[EMU1]} can be the clock model_{[CA]} or the clock model_{[CB]}. The clock model_{[CA]} and the clock model_{[CB]} is pre-reserved with the same external port. In FIG. 15, D represents a data input, Q represents a data output, Ev represents a user enable, and MC represents a clock input, wherein, the user enable_{[Ev]} of the clock models_{[EMU1]} and the user enable_{[Ev]} of the clock models_{[EMU4]} are connected to the same anchor point anchor 1, the user enable_{[E1]} of the clock models_{[EMU2]} and the user enable_{[Ev]} of the clock models_{[EMU3]} are connected to the same anchor point anchor 2, and the user clocks_{[UC1]} connected to the clock models_{[EMU1]} and the clock models_{[EMU4]} are the same, and the user clocks_{[UC2]} connected to the clock models_{[EMU2]} and the clock models_{[EMU3]} are the same. For the clock detector, when the input user clocks are the same, the output results of clock detector are the same. Therefore, the clock models connected to the same user clock can share the same clock detector, that is, the clock models_{[EMU1]} and the clock models_{[EMU4]} share a same clock detector, and the clock models_{[EMU2]} and the clock models_{[EMU3]} share a same clock detector.

Combination of common clock detectors includes the following three examples.

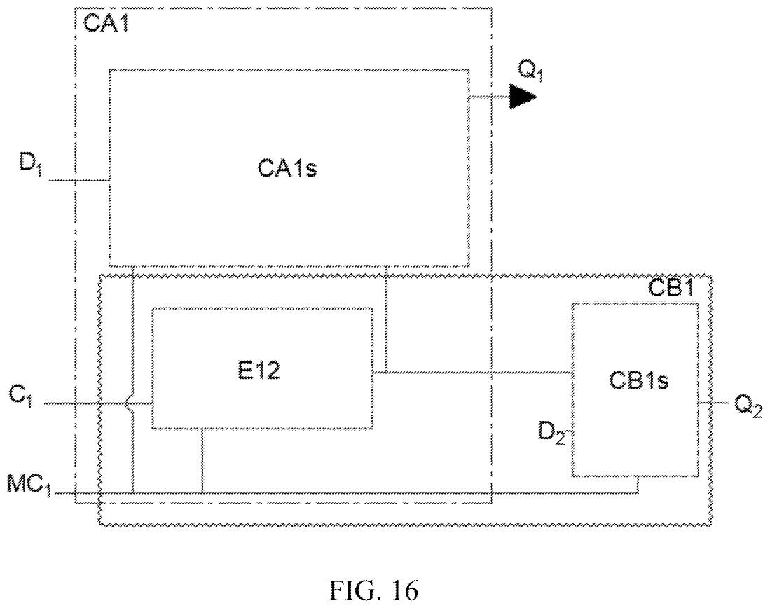

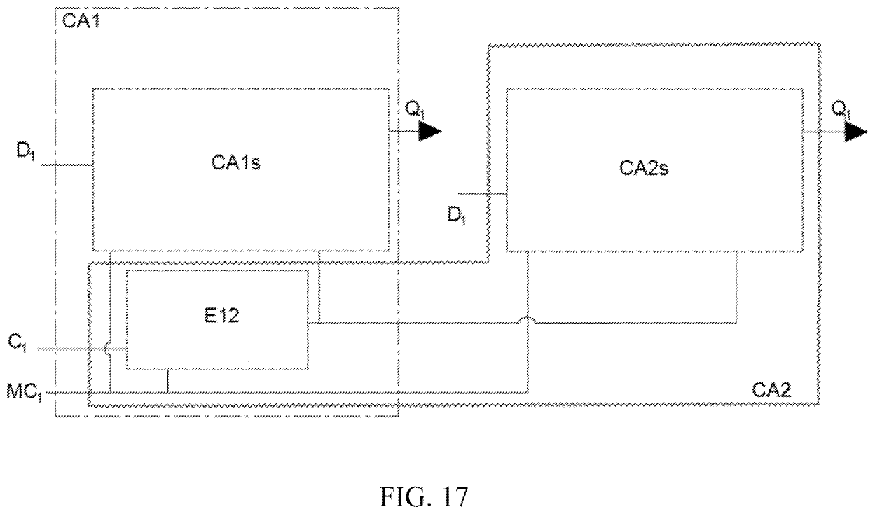

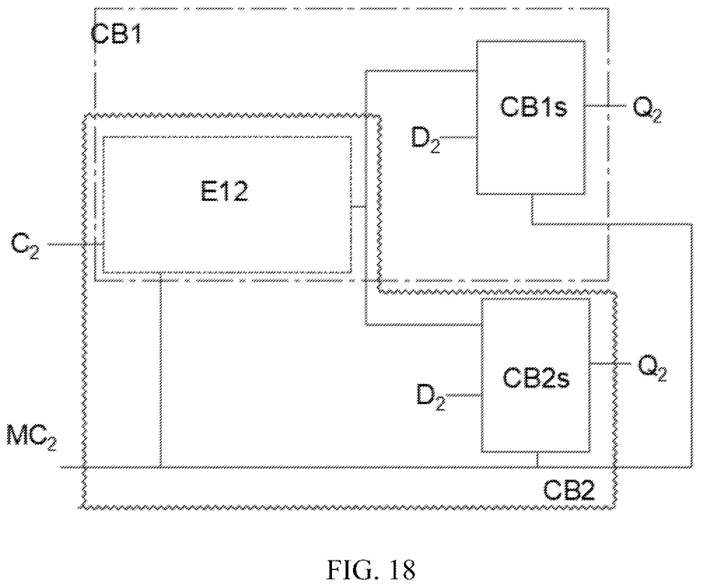

Preferably, for the condition that the clock models of different types are connected to the same anchor, referring to FIG. 16, in S1, the plurality of sequential cells include: a sequential cell_{[A1]} and a sequential cell_{[B1]}. In S2, the sequential cell 1_{[A1]} is labelled as group A, and the sequential cell_{[B1]} is labelled as group B. In S3.1: the sequential cell_{[A1]} is substituted with a clock model_{[CA1]}, and the clock model_{[CA1]} is configured to include a data input_{[CA1]}, a data output_{[CA1]}, a user enable_{[CA1]} and a clock input_{[CA1]}. In S3.2: the sequential cell_{[B1]} is substituted with a clock model_{[B1]}, and the clock model_{[B1]} is configured to include a data input_{[B1]}, a data output_{[B1]}, a user enable_{[B1]} and a clock input_{[B1]}. The S3 further includes configuring for the clock model_{[CA1]} a sampler_{[CA1s]}; configuring for the sampler_{[CA1s]} a data input_{[CA1s]}, an enable_{[CA1s]}, a clock input_{[CA1s]} and a data output_{[CA1s]}; configuring for the clock model_{[CB1]} a sampler_{[CB1s]}; configuring for the sampler_{[CB1s]} a data input_{[CB1s]}, an enable_{[CB1s]}, a clock input_{[CB1s]} and a data output_{[CB1s]}; identifying an anchor to which the user enable_{[CA1]} is connected, and if the user enable_{[CB1]} is connected to the anchor: configuring jointly for the clock model_{[CA1]} and for the clock model_{[CB1]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CA1]} and the user enable_{[CB1]}; connecting the clock input_{[E12]} to the clock input_{[CA1s]}, the clock input_{[CA1]}, the clock input_{[CB1s]} and the clock input_{[CB1}; connecting the active-edge output_{[E12]} to the enable_{[CA1s]} and to the enable_{[CB1s]}; connecting the data input_{[CA1s]} to the data input_{[CA1]}; connecting the data output_{[CA1s]} to the data output_{[CA1]}; connecting the data input_{[CB1s]} to the data input_{[CB1]}; and connecting the data output_{[CB1s]} to the data output_{[CB1]}. As shown in FIG. 16, C₁ represents both the user clock_{[A]} connected to the user enable_{[CA]} and the user clock_{[B]} connected to the user enable_{[CB]}; and MC₁ represents both the primary clock′ connected to the clock input_{[CA]} and the primary clock′ connected to the clock input_{[CB]}. By making the clock model_{[CA]} and clock model_{[CB]} connected to a same anchor share one clock detector, it can not only obtain the same active edge as the unshared clock detector, but also greatly reduce use of clock detectors and reduce consumption of hardware resources. Preferably, for the condition that a plurality of clock models_{[CA]} are connected to a same anchor, referring to FIG. 17, in S1, the plurality of sequential cells include: a sequential cell_{[A1]} and a sequential cell_{[A2]}. In S2, the sequential cell_{[A1]} and the sequential cell_{[A2]} are both labelled as group A. in S3.1, the sequential cell_{[A1]} is substituted with a clock model_{[CA1]}; the clock model_{[CA1]} is configured to include a data input_{[CA1]}, a data output_{[CA1]}, a user enable_{[CA1]} and a clock input_{[CA1]}; the sequential cell_{[CA2]} is substituted with a clock model_{[CA2]}; and the clock model_{[CA2]} is configured to include a data input_{[CA2]}, a data output_{[CA2]}2, a user enable_{[CA2]} and a clock input_{[CA2]}. The S3 further includes: configuring for the clock model_{[CA1]} a sampler_{[CA1s]}; configuring for the sampler_{[CAs1]} a data input_{[CA1s]}, an enable_{[CA1s]}, a clock input_{[CA1s]} and a data output_{[CA1s]}; configuring for the clock model_{[CA2]} a sampler_{[CA2s]}; configuring for the sampler_{[CA2s]} a data input_{[CA2s]}, an enable_{[CA2s]}, a clock input_{[CA2s]} and a data output_{[CA2s]}; identifying an anchor to which the user enable_{[CA1]} is connected; and if the user enable_{[CA2]} is connected to the anchor: configuring jointly for the clock model_{[CA1]} and for the clock model_{[CA2]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CA1]} and the user enable_{[CA2]}; connecting the clock input_{[E12]} to the clock input_{[CA1s]}, the clock input_{[CA1]}, the clock input_{[CA2s]} and the clock input_{[CA2]}; connecting the active-edge output_{[E12]} to the enable_{[CA1s]} and to the enable_{[CA2s]}; connecting the data input_{[CA1s]} to the data input_{[CA1]}; connecting the data output_{[CA1s]} to the data output_{[CA1]}; connecting the data input_{[CA2s]} to the data input_{[CA2]}; and connecting the data output_{[CA2s]} to the data output_{[CA2]}. As shown in FIG. 17, since the clock detector_{[E12]} is used in common, C₁ represents both the user clock_{[A]} connected to the user enable_{[CA1]} and the user clock_{[A]} connected to the user enable_{[CA2]}; and MC₁ represents both the primary clock′ connected to the clock input_{[CA1]} and the primary clock′ connected to the clock input_{[CA2]}. By making two or more clock models_{[CA]} connected to the same anchor share one clock detector, it can not only obtain the same active edge as the unshared clock detector, but also greatly reduce use of clock detectors and reduce consumption of hardware resources. Preferably, for the condition that a plurality of clock models_{[CB]} are connected to a same anchor, referring to FIG. 18, in the S1, the a plurality of sequential cells include: a sequential cell_{[B1]} and a sequential cell_{[B2]}. In S2, the sequential cell_{[B1]} and sequential cell_{[B2]} are labelled as group B. In S3.1, the sequential cell_{[B1]} is substituted with a clock model_{[CB1]}; the clock model_{[CB1]} is configured to include a data input_{[CB1]}, a data output_{[CB1]}, a user enable_{[CB1]} and a clock input_{[CB1]}; the sequential cell_{[B2]} is substituted with a clock model_{[CB2]}; and the clock model_{[CB2]} is configured to include a data input_{[CB2]}, a data output_{[CB2]}, a user enable_{[CB2]} and a clock input_{[CB2]}. The S3 further includes: configuring for the clock model_{[CB1]} a sampler_{[CB1s]}; configuring for the sampler_{[CBs1]} a data input_{[CB1s]}, an enable_{[CB1s]}, a clock input_{[CB1s]} and a data output_{[CB1s]}; and configuring for the sampler_{[CB2s]} a data input_{[CB2s]}, an enable_{[CB2s]}, a clock input_{[CB2s]} and a data output_{[CB2s]}; identifying an anchor to which the user enable_{[CB1]} is connected; and if the user enable_{[CB2]} is connected to the anchor: configuring jointly for the clock model_{[CB1]} and for the clock model_{[CB2]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CB1]} and the user enable_{[CB2]}; connecting the clock input_{[E12]} to the clock input_{[CB1s]}, the clock input_{[CB1]}, the clock input_{[CB2s]} and the clock input_{[CB2]}; connecting the active-edge output_{[E12]} to the enable_{[CB1s]} and to the enable_{[CB2s]}; connecting the data input_{[CB1s]} to the data input_{[CB1]}; connecting the data output_{[CB1s]} to the data output_{[CB1]}; connecting the data input_{[CB2s]} to the data input_{[CB2]}; and connecting the data output_{[CB2s]} to the data output_{[CB2]}. As shown in FIG. 18, since the clock detector_{[E12]} is used in common, C₂ represents both the user clock_{[B]} connected to the user enable_{[CB1]} and the user clock_{[B]} connected to the user enable_{[CB2]}; and MC₁ represents both the primary clock′ connected to the clock input_{[CB1]} and the primary clock′ connected to the clock input_{[CB2]}. By making two or more clock models_{[CB]} connected to a same anchor share one clock detector, it can not only obtain the same active edge as the unshared clock detector, but also greatly reduce use of clock detectors and reduce consumption of hardware resources.

Referring to FIG. 3 again, FIG. 3 shows a comparison diagram before and after modification. In order to better express the relationship before and after modification, the same letter used in the diagram is unchanged to indicate that the signal connected to each port before and after modification. Referring to the part a of FIG. 3, which shows structure among sequential cells of an IC design before modification, for any one register_{[FFi]} before modification, the register_{[FFi]} comprises a clock input_{[C]}, a data input_{[D]} and data output_{[Q]}, wherein the Lo is a combinational logic circuit. The clock input_{[C]} of the register_{[FFi]} is connected to the user clock_{[UCi]}, the data input_{[D]} is connected to data signal_{[D1]}, and the data output_{[Q]} outputs data signal_{[Qi]}. Referring to the part b of FIG. 3, which shows structure schematic drawing of the clock model after modification, to better express relationship among ports, D is also adopted in the part b of FIG. 3 to represent a data input_{[CA]} of a clock model_{[CA]} or a clock input_{[CB]} of a clock model_{[CB]}, Q represents a data output_{[CA]} of a clock model_{[CA]} or a data output_{[CB]} of a clock model_{[CB]}, Ev represents a user enable_{[CA]} of a clock model_{[CA]} or a user enable_{[CB]} of a clock model_{[CB]}, and the register_{[FFi]} is substituted with a clock model_{[CAi]}. The data signal_{[Di]} is connected to a data input_{[D]} of a clock model_{[CAi]}, the user clock_{[UCi]} is connected to the user enable_{[Ev]} of the clock model_{[CAi]}, a data output_{[Q]} of the clock model_{[CAi]} outputs data signal_{[Q1}], and a clock input_{[C]} of the clock model_{[CAi]} is connected to the primary clock′. The register_{[FFi]} is substituted with a clock model_{[CAj]} by the same method, and register_{[FFp]} is substituted with a clock model_{[CAp]}, and the clock inputs of clock model_{[CAi]}, clock model_{[CAj]} and clock model_{[CBp]} are connected to corresponding clock signals_{[MC]}, respectively.

Wherein, the substituted circuit comprises a p-th clock model_{[CA]} and a g-th clock model_{[CB]}, which are series-connected, and the user enable_{[CA]} of the p-th clock model_{[CA]} and the user enable_{[CB]} of the g-th clock model_{[CB]} are connected to a same user clock. The series relationship is that the data output of the previous-level clock model is connected to the data input of the next-level clock model. The modified circuit also comprises a v-th clock model_{[CB]} and a q-th clock model_{[CB]}, which are series-connected, and the user enable_{[CB]} of the v-th clock model_{[CB]} and the user enable_{[CB]} of the q-th clock model_{[CB]} are connected to a same user clock. The v-th clock model_{[CB]} and the q-th clock model_{[CB]} also can be connected to a same primary clock′. The problem of timing sequence disorder caused by clock models_{[CB]} used in cascade structure can be solved by using two clock models_{[CA]}.
3.3) the primary clock′ is configured such that: the primary clock′ by which the clock model_{[CA]} is driven triggers an active edge at a same point_{[TA]} in a period across the clock models_{[CA]}; the primary clock′ by which the clock model_{[CB]} is driven triggers an active edge at a same point_{[TB]} in a period across the clock models_{[CB]}; and TB=TA+Δt for a same period of the primary clock′, wherein: a minimum threshold<Δt<a period of the primary clock′; the minimum threshold is a maximum of delays across the user clocks_{[B]} connected to the clock models_{[CB]} for replacing the plurality of sequential cells being labeled as group B; and the delay is a time lag between when an active edge occurring on a user clock_{[B]} is being inputted into a clock detector in the clock model_{[CB]} driven by the user clock_{[B]} and when the active edge is being outputted from the clock detector.

Preferably, an active edge of the primary clock′ that drives the clock model is designated to be a rising edge or a falling edge. Preferably, S3 further includes designating the active edges of the primary clocks' that drives the clock model_{[CA]} and the clock model_{[CB]} to be any one as the follows: designating the active edge of the primary clock′ that drives the clock model_{[CA]} to be triggered by a rising edge or a falling edge; and designating the active edge of the primary clock′ that drives the clock model_{[CB]} to be triggered by a rising edge or a falling edge. When the active edges of the primary clocks' that drive the clock model_{[CA]} and the clock model_{[CB]} are both designated to be triggered by a rising edge, the clock offset between the rising edges is Δt; when the active edges of the primary clocks' that drive the clock model_{[CA]} and the clock model_{[CB]} are both designated to be triggered by a falling edge, the clock offset between the falling edges is Δt; when the active edge of the primary clock′ that drives the clock model_{[CA]} is designated to be triggered by a rising edge and the active edge of the primary clock′ that drives the clock model_{[CB]} is designated to be triggered by a falling edge, the clock offset between the rising edge and the falling edge is Δt; or when the active edge of the primary clock′ that drives the clock model_{[CA]} is designated to be triggered by a falling edge and the active edge of the primary clock′ that drives the clock model_{[CB]} is designated to be triggered by a rising edge, the clock offset between the falling edge and the rising edge is Δt.

Further, S3 further includes: connecting the clock model_{[CA]} and the clock model_{[CB]} to the same primary clock′; setting the primary clock′ to last for the Δt at its high logic state if the clock model_{[CA]} is triggered by a rising edge but the clock model_{[CB]} is triggered by a falling edge; and setting the primary clock′ to last for the Δt at its low logic state if the clock model_{[CA]} is triggered by a falling edge but the clock model_{[CB]} is triggered by a rising edge. When the clock model_{[CA]} and the clock model_{[CB]} are driven by a same primary clock′, the active edge of the primary clock′ that drives the clock model_{[CA]} is configured to be triggered by a rising edge and the active edge of the primary clock′ that drives the clock model_{[CB]} is configured to be triggered by a falling edge, the primary clock′ lasts at high logic state for Δt; and when the clock model_{[CA]} and the clock model_{[CB]} are driven by a same primary clock′, the active edge of the primary clock′ that drives the clock model_{[CA]} is configured to be triggered by a falling edge and the active edge of the primary clock′ that drives the clock model_{[CB]} is configured to be triggered by a rising edge, the primary clock′ lasts at low logic state for Δt.

Preferably, when the active edge is configured to be triggered by a rising edge, the clock detector adopts a clock detector for detecting a rising edge, such as the clock detector_{[E1]} in the FIG. 1. When the active edge is configured to be triggered by a falling edge, the clock detector adopts a clock detector for detecting a falling edge. In this case that the clock detector adopts a clock detector for detecting a falling edge, the differences between the clock detector_{[E1]} and the clock detector_{[E2]} are that: the data output_{[Re3]} of the third state holder_{[Re3]} is directly connected to the second data input_{[A1]} of a gate circuit, a non-gate circuit_{[A0]} is configured such that the non-gate input of the non-gate circuit is connected to the user enable_{[E1]}, and the non-gate output is connected to the first data input_{[A1]} of the gate circuit. All clock detectors capable of detecting rising edges, falling edges or bilateral edges in the prior art fall within the protection scope of the present invention.

The substitution of the sequential cells in group A with clock models_{[CA]} can reduce number of introduced clock domains, thereby reducing consumption of BUFG resources. The sequential cells in group B are substituted with clock models_{[CB]}. The clock model_{[CB]} has simple structure, and can effectively reduce resource consumption. The cooperation of group A and group B can reduce the overall resource consumption of the system, not only can solve glitch problem, and but also can balance the problem of high hardware resource cost caused by all using of clock models_{[CA]} to substitute sequential cells and the problems of a plurality of timing sequence domains and timing sequence disorder caused by all using of clock models_{[CB]}, simultaneously.

It should be noted that, the number of the clock models_{[CB]} is larger than that of the clock models_{[CA]}. In actual circuits, the number of the sequential cells labeled as group B is far larger than that of the sequential cells labeled as group A, so that more clock models_{[CB]} can be used after substitution, thereby reducing resource consumption of the system.

For the clock models_{[CB]} in group B, when the data signal from the data output of the j-th sequential cell is connected to the data input of the g-th sequential cell, the j-th sequential cell and the g-th sequential cell are both substituted with clock models_{[CB]}. For two clock models_{[CB]} connected in series, the timing sequences of the two clock models_{[CB]} are exactly the same when the primary clocks' connected to the two are the same, thereby avoiding the problem of timing sequence disorder and reducing resource consumption of the system.

Preferably, the method further includes: wherein, in S1, the a plurality of sequential cells include: a sequential cell_{[A1]}, a sequential cell_{[B1]} and a sequential cell_{[B2]}. In S2, the sequential cell_{[A1]} is labelled as group A, the sequential cell_{[B1]} is labelled as group B and the sequential cell_{[B2]} is labelled as group B. In S3.1: the sequential cell_{[A1]} is substituted with a clock model_{[CA1]}, and the clock model_{[CA1]} is configured to include a data input_{[CA1]}. In S3.2, the sequential cell_{[B1]} is substituted with a clock model_{[B1]}; the clock model_{[B1]} is configured to include a data input_{[CB1]} and a data output_{[CB1]}; the sequential cell_{[B2]} is substituted with a clock model_{[CB2]}; the clock model_{[CB2]} is configured to include a data input_{[CB2]} and a data output_{[CB2]}; the data output_{[CB2]} is connected to the data input_{[CA1]}; and transmission of data from the data output_{[CB2]} to the data input_{[CA1]} takes an offset time. The S3 further includes S3.4: labelling a sequential cell_{[B2]} as group A, including: 3.4.1) modifying the sequential cell_{[B2]} in view of S3.1; 3.4.2) configuring the primary clock′ in view of S3.3 such that transmission of data from the data output_{[CB1]} to the data output_{[CB2]} takes the offset time. The offset time is transferred by adjusting types of clock substituting models to further increase the maximal clock frequency of a system and improve performance of the system.

It should be noted that: all clock models_{[CA]} in the group A are within a same clock domain, and the less the clock domain is introduced, the less resources of the BUFG are required, so as to further save resource consumption of the system. The whole system can simultaneously started-up and paused by controlling one primary clock′.

It should be noted that: the primary clocks' that drive all clock models_{[CB]} in group B are the same.

Preferably, a process for obtaining F(x−t_{M}) includes: obtaining a clock signal_{[Tc]}; performing X frequency division to the clock signal_{[Tc]} to obtain frequency-divided signal, which is F(x); delaying the frequency-divided signal by time t_{M} to obtain F(x−t_{M}), and so on, obtaining waveforms of the primary clocks' at other nodes by the same method. Understandably, the clock frequency of the frequency-divided signal is 1/X times of that of the clock signal_{[Tc]}. The clock signals of the first clock substituting model and the second clock substituting model can be obtained by frequency division of the clock signal, so as to further reduce number of introduced clock domains, wherein the clock signal_{[Tc]} can be a crystal signal.

Preferably, a method for X frequency division of the clock signal_{[Tc]} includes: inputting the clock signal_{[Tc]} into a frequency divider to obtain a frequency-divided signal, wherein X is larger than 0.

Preferably, a method for delaying the frequency-divided signal by time τ includes: inputting the frequency-divided signal into a delay circuit.
S4) converting the IC design into a modified design;
S5) implementing the modified design on the FPGA; and
S6) validating the IC design with the FPGA on which the modified design is implemented.

In conclusion, an embodiment of the present invention provides a method for emulating an IC design with an FPGA, comprising: firstly identifying a port of a sequential cell, and labeling the sequential cell as group A if the data output of the sequential cell is connected to a user-clock input of another sequential cell; labeling the sequential cell as group B if the data output of the sequential cell is not connected to the user-clock input of the other sequential cell and is connected to a data input of the other sequential cell; modifying all sequential cells that are labeled as group A with clock models_{[CA]}, modifying all sequential cells that are labeled as group B with clock models_{[CB]}; the clock model_{[CA]} and the clock model_{[CB]} solving glitch problem by connecting glitch-containing user clock with a user enable non-sensitive to glitch; connecting the clock models_{[CA]} in group A to a same primary clock′, connecting the clock models_{[CB]} in group B to a same primary clock′, so as to be able to greatly reduce numbers of clock domains, thereby reducing resource consumption and making the whole system paused by controlling less primary clocks′; and by configuring the clock offset between the primary clock′ that drives the clock model_{[CA]} and the primary clock′ that drives the clock model_{[CB]}, both are sampled in the same clock period.

Based on the same inventive conception as the methods in embodiments, an embodiment of the present invention also provides a system for emulating an IC design with an FPGA, comprising a processor and a computer-readable storage medium in communication with the processor, wherein: the system implements the method for emulating an IC design with an FPGA and provided in any one embodiment aforementioned when the processor executes a program in the computer-readable storage medium.

Wherein, the processor can comprise one or more processing cores, such as 4-core processor, 12-core processor, etc. The processor can realize processing by using at least one hardware form of a digital signal processing (DSP), a field programmable gate array (FPGA) and a programmable logic array (PLA). The processor can also include a host processor and a coprocessor. The host processor is a processor used to process the data in a wake state, also known as CPU. The coprocessor is a low-power processor used to process data in standby mode. In some embodiments, the processor may be integrated with a graphics processing unit (GPU), which is responsible for rendering and painting the content required by the display. In some embodiments, the processor may also include an artificial intelligence (AI) processor for processing computational operations concerning machine learning.

Wherein, the computer-readable storage medium is a memory device in a computer device, and is used to store information such as computer readable instructions, data structures, program modules or other data. Understandably, the storage medium herein can include a built-in storage medium in the computer device, and, of course, can include an extended storage medium supported by a computer device. The storage medium provides a storage space, in which one or more computer instructions loadable and executable by the processor are also are stored. These computer instructions may be one or more computer programs (including program code). It should be noted that the storage medium herein can be a high-speed RAM memory, and also can be a non-volatile memory. For example, the memory medium comprises RAM, ROM, erasable programmable read-only memory (EPROM), electrically erasable programmable read-only memory (EEPROM), flash memory or other solid memories, CD-ROM, digital video disc (DVD) or other optical memories, tape cartridge, tape, memories or other magnetic memory device, etc. Of course, the skilled in the field know that computer storage media are not limited to the aforementioned.

Based on the same inventive conception as the methods in embodiments, an embodiment of the present invention also provides a non-transitory computer-readable storage medium in which at least one instruction or at least one program is stored, wherein: the at least one instruction or the at least one program is loadable and executable by a processor to implement the method for emulating an IC design with an FPGA and provided in any one embodiment aforementioned, wherein the method for emulating an IC design with an FPGA is described in detail in the method embodiments, and here detailed description is avoided.

What is claimed is:

1. A method for emulating an IC design with an FPGA, comprising the steps of:
S1) identifying in the IC design:
a primary clock;
a subcircuit;
a plurality of generated clocks, which are derived from the primary clock after being processed by the subcircuit; and
a plurality of sequential cells, wherein a user clock being connected to one of the plurality of sequential cells is the primary clock or one of the plurality of generated clocks;
S2) classifying the plurality of sequential cells into group A and group B, including:
2.1) labeling a sequential cell in the plurality of sequential cells as group A or group B;
2.1.1) identifying on the sequential cell:
a user clock by which the sequential cell is driven;
a data input;
a user-clock input to which the user clock is connected; and
a data output;
2.1.2) labeling the sequential cell as group A if the data output is connected to a user-clock input of an other sequential cell; and
2.1.3) labeling the sequential cell as group B if the data output is not connected to the user-clock input of the other sequential cell but is connected to a data input of the other sequential cell; and
2.2) labeling the rest of the plurality of sequential cells as group A or group B; and
S3) adapting the plurality of sequential cells, including:
3.1) modifying the sequential cells that are labeled as group A, including:
3.1.1) configuring a clock model_{[CA]}, which includes a data input_{[CA]}, a data output_{[CA]}, a user enable_{[CA]} and a clock input_{[CA]};
3.1.2) modifying a sequential cell_{[A]} in the plurality of sequential cells being labelled as group A, including:
i) identifying in view of S2:
a user clock_{[A]} by which the sequential cell_{[A]} is driven;
a data input_{[A]};
a user-clock input_{[A]} to which the user clock_{[A]} is connected; and
a data output_{[A]};
ii) substituting the clock model_{[CA]} for the sequential cell_{[A]}, including:
connecting the data input_{[A]} to what was connected to the data input_{[A]};
connecting the data output_{[CA]} to what was connected to the data output_{[A]};
connecting the user enable_{[CA]} to what was connected to the user-clock input_{[A]}; and
connecting the clock input_{[CA]} to a primary clock′ which is equal to or greater than the primary clock in frequencies; and
iii) configuring the clock model_{[CA]}, including:
sampling a signal from the data input_{[CA]} at an active edge of the primary clock′ to obtain a data sample for a period of the primary clock′ led by the active edge;
when an N-th active edge is occurring on the user clock_{[A]}:
obtaining a data sample_{[N]} for a contemporary period of the primary clock′; and
outputting to the data output_{[CA]} the data sample_{[N]} until an N+1-th active edge occurs on the user clock_{[A]}; and
when the N+1-th active edge is occurring on the user clock_{[A]}:
obtaining a data sample_{[N+1]} for a contemporary period of the primary clock′; and
outputting to the data output_{[CA]} the data sample_{[N+1]} until an N+2-th active edge occurs on the user clock_{[A]}; and
3.1.3) modifying the rest of sequential cells_{[A]} in the plurality of sequential cells being labelled as group A; and
3.2) modifying the sequential cells that are labeled as group B, including:
3.2.1) configuring a clock model_{[CB]}, which includes a data input_{[CB]}, a data output_{[CB]}, a user enable_{[CB]} and a clock input_{[CB]};
3.2.2) modifying a sequential cell_{[B]} in the plurality of sequential cells being labelled as group B, including:
i) identifying in view of S2:
a user clock_{[B]} by which the sequential cell_{[B]} is driven;
a data input_{[B]};
a user-clock input_{[B]} to which the user clock_{[B]} is connected; and
a data output_{[B]};
ii) substituting the clock model_{[CB]} for the sequential cell_{[B]}, including:
connecting the data input_{[CB]} to what was connected to the data input_{[B]};
connecting the data output_{[C]} to what was connected to the data output_{[B]};
connecting the user enable_{[CB]} to what was connected to the user-clock input_{[B]}; and
connecting the clock input_{[B]} to a primary clock′ which is equal to or greater than the primary clock in frequencies; and
iii) configuring the clock model_{[CB]}, including:
when an active edge is occurring on the user clock_{[B]} and when an active edge is occurring on the primary clock′:
sampling a signal from the data input_{[CB]} to obtain a data sample for a period of the primary clock′ led by the active edge on the primary clock′; and
outputting to the data output_{[CB]} the data sample; and
when no active edge occurs on the user clock_{[B]} or no active edge occurs on the primary clock′:
sampling nothing from the data input_{[CB]}; and
outputting nothing to the data output_{[CB]}; and
3.2.3) modifying the rest of sequential cells_{[B]} in the plurality of sequential cells being labelled as group B; and
3.3) configuring the primary clock′ such that:
the primary clock′ by which the clock model_{[CA]} is driven triggers an active edge at a same point_{[TA]} in a period across the clock models_{[CA]};
the primary clock′ by which the clock model_{[CB]} is driven triggers an active edge at a same point_{[TB]} in a period across the clock models_{[CB]}; and
TB=TA+Δt for a same period of the primary clock′, wherein:
a minimum threshold<Δt<a period of the primary clock′;
the minimum threshold is a maximum of delays across the user clocks_{[B]} connected to the clock models_{[CB]} for replacing the plurality of sequential cells being labeled as group B; and
the delay is a time lag between when an active edge occurring on a user clock_{[B]} is being inputted into a clock detector in the clock model_{[CB]} driven by the user clock_{[B]} and when the active edge is being outputted from the clock detector.

2. The method in claim 1, wherein:
in S1, the plurality of sequential cells include:
a sequential cell_{[A1]};
a sequential cell_{[B1]}; and
a sequential cell_{[B2]};
in S2:
the sequential cell_{[A1]} is labelled as group A;
the sequential cell_{[B1]} is labelled as group B; and
the sequential cell_{[B2]} is labelled as group B;
in S3.1:
a clock model_{[CA1]} is substituted for the sequential cell_{[A1]}; and
the clock model_{[CA1]} is configured to include a data input_{[CA1]};
in S3.2:
a clock model_{[CB1]} is substituted for the sequential cell_{[B1]};
the clock model_{[CB1]} is configured to include a data input_{[CB1]} and a data output_{[CB1]};
a clock model_{[CB2]} is substituted for the sequential cell_{[B2]}; and
the clock model_{[CB2]} is configured to include a data input_{[CB2]} and a data output_{[CB2]};
the data output_{[CB1]} is connected to the data input_{[CB2]};
the data output_{[CB2]} is connected to the data input_{[CA1]};
transmission of data from the data output_{[CB2]} to the data input_{[CA1]} takes an offset time; and
S3 further includes S3.4:
3.4) re-labelling the sequential cell_{[B2]} as group A, including:
3.4.1) modifying the sequential cell_{[B2]} in view of S3.1; and
3.4.2) configuring the primary clock′ in view of S3.3 such that transmission of data from the data output_{[CB1]} to the data output_{[CB2]} takes the offset time.

3. The method in claim 1, wherein S3.1 further includes:
configuring for the clock model_{[CA]} a clock detector_{[E1]} and a sampler_{[CAs]};
configuring for the clock detector_{[E1]} a user enable_{[E1]}, a clock input_{[E1]} and an active-edge output_{[E1]};
configuring for the sampler_{[CAs]} a data input_{[CAs]}, an enable_{[CAs]}, a clock input_{[CAs]} and a data output_{[CAs]};
connecting the user enable_{[E1]} to the user enable_{[CA]};
connecting the clock input_{[E1]} and the clock input_{[CAs]} to the clock input_{[CA]};
connecting the active-edge output_{[E1]} to the enable_{[CAs]};
connecting the data input_{[CAs]} to the data input_{[CA]}; and
connecting the data output_{[CAs]} to the data output_{[CA]}.

4. The method in claim 3, wherein S3.1 further includes:
configuring for the sampler_{[CAs]} a first state holder_{[Re1]}, a second state holder_{[Re2]} and a multiplexer_{[MUX1]};
configuring for the first state holder_{[Re1]} a clock input_{[Re1]}, a data input_{[Re1]} and a data output_{[Re1]};
configuring for the second state holder_{[Re2]} a clock input_{[Re2]}, a data input_{[Re2]} and a data output_{[Re2]};
configuring for the multiplexer_{[MUX1]} a first data input_{[MUX1]}, a second data input_{[MUX1]}, a signal selection_{[MUX1]} and a data output_{[MUX1]};
connecting the data input_{[Re1]} to the data input_{[CAs]};
connecting the data output_{[MUX1]} to the data output_{[CAs]};
connecting the clock input_{[Re1]} and the clock input_{[Re2]} to the clock input_{[CAs]};
connecting the data output_{[Re1]} to the first data input_{[MUX1]};
connecting the data input_{[Re2]} to the data output_{[MUX1]};
connecting the data output_{[Re2]} to the second data input_{[MUX1]}; and
connecting the enable_{[CAs]} to the signal selection_{[MUX1]}.

5. The method in claim 1, wherein:
S2 further includes identifying on the sequential cell:
a data input;
a user-clock input;
a data output; and
an enable; and
S3.1 further includes:
configuring for the clock model_{[CA]} a data input_{[CA]}, a data output_{[CA]}, a user enable_{[CA]}, a clock input_{[CA]} and an enable_{[CA]};
configuring for the clock model_{[CA]} a clock detector_{[E1]}, a first state holder_{[Re1]}, a second state holder_{[Re2]}, a multiplexer_{[MUX1]} and a multiplexer_{[MUX2]};
configuring for the clock detector_{[E1]} a user enable_{[E1]}, a clock input_{[E1]} and an active-edge output_{[E1]};
configuring for the first state holder_{[Re1]} a clock input_{[Re1]}, a data input_{[Re1]} and a data output_{[Re1]};
configuring for the second state holder_{[Re2]} a clock input_{[Re2]}, a data input_{[Re2]} and a data output_{[Re2]};
configuring for the multiplexer_{[MUX1]} a first data input_{[MUX1]}, a second data input_{[MUX1]}, a signal selection_{[MUX1]} and a data output_{[MUX1]};
configuring for the multiplexer_{[MUX2]} a first data input_{[MUX2]}, a second data input_{[MUX2]}, a signal selection_{[MUX2]} and a data output_{[MUX2]};
connecting the second data input_{[MUX2]} to the data input_{[CA]};
connecting the data output_{[MUX1]} to the data output_{[CA]}, the data input_{[Re2]} and the first data input_{[MUX2]};
connecting the clock input_{[Re1]}, the clock input_{[Re2]} and the clock input to the clock input_{[CA]};
connecting the user enable_{[E1]} to the user enable_{[CA]};
connecting the active-edge output_{[E1]} to the signal selection_{[MUX1]};
connecting the data output_{[Re2]} to the second data input_{[MUX1]};
connecting the enable_{[CA]} to the signal selection_{[MUX2]};
connecting the data output_{[MUX2]} to the data input_{[Re1]}; and
connecting the data output_{[Re1]} to the first data input_{[MUX1]}.

6. The method in claim 5, wherein:
the first state holder_{[Re1]} is configured to be a register or a latch; and
the second state holder_{[Re2]} is configured to be a register or a latch.

7. The method in claim 1, wherein S3.2 further includes:
configuring for the clock model_{[CB]} a clock detector_{[E2]} and a sampler_{[CBs]};
configuring for the clock detector_{[E2]} a user enable_{[E2]}, a clock input_{[E2]} and an active-edge output_{[E2]};
configuring for the sampler_{[CBs]} a clock input_{[CBs]}, an enable_{[CBs]}, a data input_{[CBs]} and a data output_{[CBs]};
connecting the data input_{[CBs]} to the data input_{[CB]};
connecting the data output_{[CBs]} to the data output_{[CB]};
connecting the clock input_{[E2]} and the clock input_{[CBs]} to the clock input_{[CB]};
connecting the user enable_{[E2]} to the user enable_{[CB]}; and
connecting the active-edge output_{[E2]} to the enable_{[CBs]}.

8. The method in claim 7, wherein the sampler_{[CBs]} is configured to be a register having an enable.

9. The method in claim 7, wherein S3.2 further includes:
configuring for the sampler_{[CBs]} a fourth state holder_{[Re4]} and a multiplexer_{[MUX3]};
configuring for the fourth state holder_{[Re4]} a clock input_{[Re4]}, a data input_{[Re4]} and a data output_{[Re4]};
configuring for the multiplexer_{[MUX3]} a first data input_{[MUX3]}, a second data input_{[MUX3]}, a signal selection_{[MUX3]} and a data output_{[MUX3]};
connecting the first data input_{[MUX3]} to the data input_{[CBs]};
connecting the data output_{[Re4]} to the second data input_{[MUX3]} and to the data output_{[CBs]};
connecting the clock input_{[Re4]} to the clock input_{[CBs]};
connecting the signal selection_{[MUX3]} to the enable_{[CBs]}; and
connecting the data output_{[MUX3]} to the data input_{[Re4]}.

10. The method in claim 1, wherein S3.2 further includes:
configuring for the clock model_{[B]} a third state holder_{[Re3]}, a fourth state holder_{[Re4]} and a lookup table_{[LUT1]};
configuring for the third state holder_{[Re3]} a clock input_{[Re3]}, a data input_{[Re3]} and a data output_{[Re3]};
configuring for the fourth state holder_{[Re4]} a clock input_{[Re4]}, a data input_{[Re4]} and a data output_{[Re4]};
configuring for the lookup table_{[LUT1]} a first data input_{[LUT1]}, a second data input_{[LUT1]}, a third data input_{[LUT1]}, a fourth data input_{[LUT1]} and a data output_{[LUT1]};
connecting the second data input_{[LUT1]} to the data input_{[CB]};
connecting the data output_{[Re4]} to the first data input_{[LUT1]} and the data output_{[CB]};
connecting the clock input_{[Re3]} and the clock input_{[Re4]} to the clock input_{[CB]};
connecting the data input_{[Re3]} and the third data input_{[LUT1]} to the user enable_{[CB]};
connecting the data output_{[Re3]} to the fourth data input_{[LUT1]}; and
connecting the data output_{[LUT1]} to the data input_{[Re4]}.

11. The method in claim 1, wherein:
S2 further includes identifying on the sequential cell:
a data input;
a user-clock input;
a data output; and
an enable; and
S3.2 further includes:
configuring for the clock model_{[CB]} a data input_{[CB]}, a data output_{[CB]}, a user enable_{[CB]}, a clock input_{[CB]} and an enable_{[CB]};
configuring for the clock model_{[CB]} a clock detector_{[E2]}, a memory cell_{[ERe1]} and a multiplexer_{[MUX4]};
configuring for the clock detector_{[E2]} a user enable_{[E2]}, a clock input_{[E2]} and an active-edge output_{[E2]};
configuring for the memory cell_{[ERe1]} a clock input_{[ERe1]}, an enable_{[ERe1]}, a data input_{[ERe1]} and a data output_{[ERe1]};
configuring for the multiplexer_{[MUX4]} a first data input_{[MUX4]}, a second data input_{[MUX4]}, a signal selection_{[MUX4]} and a data output_{[MUX4]};
connecting the second data input_{[MUX4]} to the data input_{[CB]};
connecting the signal selection_{[MUX4]} to the enable_{[CB]};
connecting the data output_{[ERe1]} to the data output_{[CB]} and to the first data input_{[MUX4]};
connecting the clock input_{[E2]} and the clock input_{[ERe1]} to the clock input_{[CB]};
connecting the user enable_{[E2]} to the user enable_{[CB]};
connecting the active-edge output_{[E2]} to the enable_{[ERe1]}; and
connecting the data output_{[MUX4]} to the data input_{[ERe1]}.

12. The method in claim 10, wherein the third state holder_{[Re3]} is configured to be a register or a latch.

13. The method in claim 10, wherein the fourth state holder_{[Re4]} is configured to be a register or a latch.

14. The method in claim 1, wherein S3 further includes:
designating the active edge of the primary clock′ that drives the clock model_{[CA]} to be a rising edge or a falling edge; and
designating the active edge of the primary clock′ that drives the clock model_{[CB]} to be a rising edge or a falling edge.

15. The method in claim 14, wherein S3 further includes:
connecting the clock model_{[CA]} and the clock model_{[CB]} to a same primary clock′;
configuring the primary clock′ to last for the Δt at its high logic state if the clock model_{[CA]} is triggered by a rising edge but the clock model_{[CB]} is triggered by a falling edge; and
configuring the primary clock′ to last for the Δt at its low logic state if the clock model_{[CA]} is triggered by a falling edge but the clock model_{[CB]} is triggered by a rising edge.

16. The method in claim 1, wherein:
in S1, the plurality of sequential cells include:
a sequential cell_{[A1]}; and
a sequential cell_{[B1]};
in S2:
the sequential cell_{[A1]} is labelled as group A; and
the sequential cell_{[B1]} is labelled as group B;
in S3.1:
the sequential cell_{[A1]} is substituted with a clock model_{[CA1]}; and
the clock model_{[CA1]} is configured to include a data input_{[CA1]}, a data output_{[CA1]}, a user enable_{[CA1]} and a clock input_{[CA1]};
in S3.2:
the sequential cell_{[B1]} is substituted with a clock model_{[CB1]}; and
the clock model_{[CB1]} is configured to include a data input_{[CB1]}, a data output_{[CB1]}, a user enable_{[CB1]} and a clock input_{[CB1]};
S3 further includes:
configuring for the clock model_{[CA1]} a sampler_{[CA1s]};
configuring for the sampler_{[CA1s]} a data input_{[CA1s]}, an enable_{[CA1s]}, a clock input_{[CA1s]} and a data output_{[CA1s]};
configuring for the clock model_{[CB1]} a sampler[CB1s];
configuring for the sampler_{[CB1s]} a data input_{[CB1s]}, an enable_{[CB1s]}, a clock input_{[CB1s]} and a data output_{[CB1s]};
identifying an anchor to which the user enable_{[CA1]} is connected; and
if the user enable_{[CB1]} is connected to the anchor:
configuring jointly for the clock model_{[CA1]} and for the clock model_{[CB1]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CA1]} and the user enable_{[CB1]};
connecting the clock input_{[E12]} to the clock input_{[CA1s]}, the clock input_{[CA1]}, the clock input_{[CB1s]} and the clock input_{[CB1]};
connecting the active-edge output_{[E12]} to the enable_{[CA1s]} and to the enable_{[CB1s]};
connecting the data input_{[CA1s]} to the data input_{[CA1]};
connecting the data output_{[CA1s]} to the data output_{[CA1]};
connecting the data input_{[CB1s]} to the data input_{[CB1]}; and
connecting the data output_{[CB1s]} to the data output_{[CB1]}.

17. The method in claim 1, wherein:
in S1, the plurality of sequential cells include:
a sequential cell_{[A1]}; and
a sequential cell_{[A2]};
in S2: the sequential cell_{[A1]} and the sequential cell_{[A2]} are both labelled as group A;
in S3.1:
the sequential cell_{[A1]} is substituted with a clock model_{[CA1]};
the clock model_{[CA1]} is configured to include a data input_{[CA1]}, a data output_{[CA1]}, a user enable_{[CA1]} and a clock input_{[CA1]};
the sequential cell_{[A2]} is substituted with a clock model_{[CA2]}; and
the clock model_{[CA2]} is configured to include a data input_{[CA2]}, a data output_{[CA2]}, a user enable_{[CA2]} and a clock input_{[CA2]};
S3 further includes:
configuring for the clock model_{[CA1]} a sampler_{[CA1s]};
configuring for the sampler_{[CAs1]} a data input_{[CA1s]}, an enable_{[CA1s]}, a clock input_{[CA1s]} and a data output_{[CA1s]};
configuring for the clock model_{[CA2]} a sampler_{[CA2s]};
configuring for the sampler_{[CA2s]} a data input_{[CA2s]}, an enable_{[CA2s]}, a clock input_{[CA2s]} and a data output_{[CA2s]};
identifying an anchor to which the user enable_{[CA1]} is connected; and
if the user enable_{[CA2]} is connected to the anchor:
configuring jointly for the clock model_{[CA1]} and for the clock model_{[CA2]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CA1]} and the user enable_{[CA2]};
connecting the clock input_{[E12]} to the clock input_{[CA1s]}, the clock input_{[CA1]}, the clock input_{[CA2s]} and the clock input_{[CA2]};
connecting the active-edge output_{[E12]} to the enable_{[CA1s]} and to the enable_{[CA2s]};
connecting the data input_{[CA1s]} to the data input_{[CA1]};
connecting the data output_{[CA1s]} to the data output_{[CA1]};
connecting the data input_{[CA2s]} to the data input_{[CA2]}; and
connecting the data output_{[CA2s]} to the data output_{[CA2]}.

18. The method in claim 1, wherein:
in S1, the plurality of sequential cells include:
a sequential cell_{[B1]}; and
a sequential cell_{[B2]};
in S2: the sequential cell_{[B1]} and the sequential cell_{[B2]} are both labelled as group B;
in S3.1:
the sequential cell_{[B1]} is substituted with a clock model_{[CB1]};
the clock model_{[CB1]} is configured to include a data input_{[CB1]}, a data output_{[CB1]}, a user enable_{[CB1]} and a clock input_{[CB1]};
the sequential cell_{[B2]} is substituted with a clock model_{[CB2]}; and
the clock model_{[CB2]} is configured to include a data input_{[CB2]}, a data output_{[CB2]}, a user enable_{[CB2]} and a clock input_{[CB2]};
S3 further includes:
configuring for the clock model_{[CB1]} a sampler_{[CB1s]};
configuring for the sampler_{[CBs1]} a data input_{[CB1s]}, an enable_{[CB1s]}, a clock input_{[CB1s]} and a data output_{[CB1s]};
configuring for the clock model_{[CB2]} a sampler_{[CB2s]};
configuring for the sampler_{[CB2s]} a data input_{[CB2s]}, an enable_{[CB2s]}, a clock input_{[CB2s]} and a data output_{[CB2s]};
identifying an anchor to which the user enable_{[CB1]} is connected; and
if the user enable_{[CB2]} is connected to the anchor:
configuring jointly for the clock model_{[CB1]} and for the clock model_{[CB2]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CB1]} and the user enable_{[CB2]};
connecting the clock input_{[E12]} to the clock input_{[CB1s]}, the clock input_{[CB1]}, the clock input_{[CB2s]} and the clock input_{[CB2]};
connecting the active-edge output_{[E12]} to the enable_{[CB1s]} and to the enable_{[CB2s]};
connecting the data input_{[CB1s]} to the data input_{[CB1]};
connecting the data output_{[CB1s]} to the data output_{[CB1]};
connecting the data input_{[CB2s]} to the data input_{[CB2]}; and
connecting the data output_{[CB2s]} to the data output_{[CB2]}.

19. The method in claim 1, further comprising the steps of:
S4) converting the IC design into a modified design;
S5) implementing the modified design on the FPGA; and
S6) validating the IC design with the FPGA on which the modified design is implemented.

20. A system for emulating an IC design with an FPGA, comprising a processor and a computer-readable storage medium in communication with the processor, wherein:
the system implements the method in claim 1 when the processor executes a program in the computer-readable storage medium.

21. A non-transitory computer-readable storage medium in which at least one instruction or at least one program is stored, wherein: the at least one instruction or the at least one program is loadable and executable by a processor to implement the method in claim 1.
